(19) United States
(12) Patent Application Publication
(10) Pub. No.: US 2025/0315669 A1
(43) Pub. Date: Oct. 9, 2025

(54) INFORMATION PROCESSING APPARATUS, INFORMATION PROCESSING METHOD, AND PROGRAM

(71) Applicant: NIPPON TELEGRAPH AND TELEPHONE CORPORATION, Tokyo (JP)

(72) Inventors: Yoshiaki TAKIMOTO, Musashino-shi (JP); Tetsuya KINEBUCHI, Musashino-shi (JP); Taichi ASAMI, Musashino-shi (JP)

(73) Assignee: NIPPON TELEGRAPH AND TELEPHONE CORPORATION, Tokyo (JP)

(21) Appl. No.: 18/862,979

(22) PCT Filed: May 10, 2022
(86) PCT No.: PCT/JP2022/019840

§ 371 Date: Nov. 5, 2024

(51) Int. Cl. G06N 3/08

(52) U.S. Cl. CPC G06N 3/08

(57) ABSTRACT

An information processing apparatus includes: a latent representation calculation unit that calculates a latent representation representing a feature amount regarding a prediction target event from processing target data including the feature amount; monotonic neural networks that are modeled to output a scalar value in accordance with a monotonically increasing function defined by the latent representation calculated by the latent representation calculation unit and a clock time; and a function estimation unit that estimates at least one of a hazard function and a survival function on the basis of the scalar value output from the monotonic neural networks.

### TECHNICAL FIELD

Embodiments relate to an information processing apparatus, an information processing method, and a program.

### BACKGROUND ART

It is important to predict occurrence of events such as device failures, human actions, crimes, earthquakes, infectious diseases, and the like for various applications.

These events include events that occur only once (including cases where occurrence is not assumed because data significantly changes after the one-time occurrence). Examples of such events include deaths, accidents, marriages, recurrence of diseases, and the like. Survival analysis is often used to predict such events.

Prediction based on survival analysis is typically performed through the following procedure.
1. Model learning (or manual design) is performed by using data obtained when an event has occurred and obtained when the event has not occurred.
2. A hazard function representing how likely an event is to occur and/or a survival function representing a probability that an event will occur after a specific period of time is obtained by using a model for data that is actually desired to be predicted.

However, such a procedure includes a plurality of problems.

A first problem is that there is not always sufficient obtained when an event that is desired to be predicted has occurred.

A second problem is that there is a strong assumption such as utilization of a COX proportional hazard model as a basis. In the case of the COX proportional hazard model, an absolute time is not known while it is possible to know how relatively likely an event is to occur. Also, in a case where a time is discretized, it is not possible to estimate a more accurate time than the discretized granularity.

A third problem is that in a case where no assumption such as the COX proportional hazard model is made, the likelihood includes an integral, and it is difficult to perform optimization, or it is necessary to perform approximation.

For such problems, Non Patent Literature 1 and Non Patent Literature 2 have been proposed.

### CITATION LIST

### Non Patent Literature

Non Patent Literature 1: Yeping Lina Qiu, et al., “A meta-learning approach for genomic survival analysis”, NATURE COMMUNICATIONS|(2020) 11:6350|https://doi.org/10.1038/s41467-020-20167-3|www.nature.com/naturecommunications
Non Patent Literature 2: Shi Nu, et al., “Transformer-Based Deep Survival Analysis”, AAAI Spring Symposium 2021 (SP-ACA)

### SUMMARY OF INVENTION

### Technical Problem

Non Patent Literature 1 discloses a method based on a COX proportional hazard model. According to the method in Non Patent Literature 1, the above first problem is solved by performing meta learning based on model-agnostic meta-learning (MAML), and the above third problem is avoided by using a COX proportional hazard model. However, the method in Non Patent Literature 1 uses the COX proportional hazard model and thus cannot solve the above second problem.

Also, Non Patent Literature 2 discloses a method of discretizing a time. The method in Non Patent Literature 2 avoids the above third problem by the discretization. However, the method in Non Patent Literature 2 has not yet solved the above first problem and cannot solve the above second problem due to the discretization.

In this way, the methods in the related art cannot solve the above second problem even if they can solve or avoid the first or third problem.

The present invention was made focusing on the above circumstances, and an object thereof is to provide means for enabling calculation of at least one of a hazard function and a survival function without any assumption.

### Solution to Problem

An information processing apparatus according to an aspect includes a latent representation calculation unit, monotonic neural networks, and a function estimation unit. The latent representation calculation unit calculates a latent representation representing a feature amount regarding a prediction target event from processing target data including the feature amount. The monotonic neural networks are modeled to output a scalar value in accordance with a monotonically increasing function defined by the latent representation calculated by the latent representation calculation unit and a clock time. The function estimation unit estimates at least one of a hazard function and a survival function on the basis of the scalar value output from the monotonic neural networks.

### Advantageous Effects of Invention

According to the embodiment, it is possible to provide means for enabling calculation of at least one of a hazard function and a survival function without any assumption.

### BRIEF DESCRIPTION OF DRAWINGS

FIG. 1 is a block diagram illustrating an example of a hardware configuration of a survival analysis device as an information processing apparatus according to a first embodiment.

FIG. 2 is a block diagram illustrating an example of a configuration of a learning function of the survival analysis device as the information processing apparatus according to the first embodiment.

FIG. 3 is a block diagram illustrating an example of a configuration of a prediction function of the survival analysis device as the information processing apparatus according to the first embodiment.

FIG. 4A is a flowchart illustrating an example of a learning operation of the survival analysis device as the information processing apparatus according to the first embodiment.

FIG. 4B is a flowchart illustrating an example of the learning operation of the survival analysis device as the information processing apparatus according to the first embodiment.

FIG. 5 is a flowchart illustrating an example of a prediction operation of the survival analysis device as the information processing apparatus according to the first embodiment.

FIG. 6 is a block diagram illustrating an example of a configuration of a learning function of a survival analysis device as an information processing apparatus according to a second embodiment.

FIG. 7 is a block diagram illustrating an example of a configuration of a prediction function of the survival analysis device as the information processing apparatus according to the second embodiment.

FIG. 8A is a flowchart illustrating an example of a learning operation of the survival analysis device as the information processing apparatus according to the second embodiment.

FIG. 8B is a flowchart illustrating an example of the learning operation of the survival analysis device as the information processing apparatus according to the second embodiment.

FIG. 9 is a flowchart illustrating an example of a prediction operation of the survival analysis device as the information processing apparatus according to the second embodiment.

### DESCRIPTION OF EMBODIMENTS

Hereinafter, some embodiments will be described with reference to the drawings. Note that in the following description, components having the same functions and configurations will be denoted by common reference signs.

### 1. First Embodiment

An information processing apparatus according to a first embodiment will be described. Hereinafter, a survival analysis device will be described as an example of the information processing apparatus according to the first embodiment.

The survival analysis device includes a learning function and a prediction function. The learning function is a function of meta-learning a parameter of a model by using obtained when an event has occurred and obtained when the event has not occurred. The prediction function is a function of calculating a hazard function, a cumulative hazard function, and a survival function for data that is actually desired to be predicted, on the basis of the parameter of the model learned by the learning function.

### 1.1 Configuration

Configurations of the survival analysis device as the information processing apparatus according to the first embodiment will be described.

### 1.1.1 Hardware Configuration

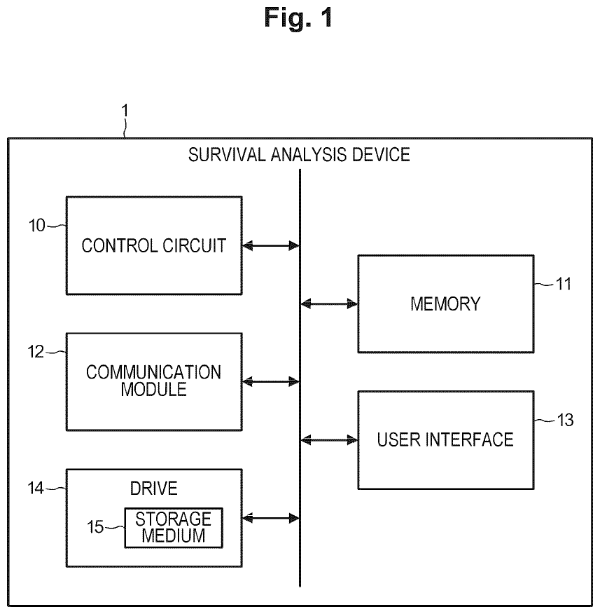

FIG. 1 is a block diagram illustrating an example of a hardware configuration of a survival analysis device 1 as the information processing apparatus according to the first embodiment. As illustrated in FIG. 1, the survival analysis device 1 includes a control circuit 10, a memory 11, a communication module 12, a user interface 13, and a drive 14.

The control circuit 10 is a circuit that controls each component of the survival analysis device 1 as a whole. The control circuit 10 includes a central processing unit (CPU), a random access memory (RAM), a read only memory (ROM), and the like. The CPU can execute a plurality of information processing tasks at the same time by using a multi-core or a multi-thread CPU. Also, the control circuit 10 may include a plurality of CPUS. In addition, the control circuit 10 can include an integrated circuit such as an application specific integrated circuit (ASIC), a digital signal processor (DSP), a field-programmable gate array (FPGA), or a graphics processing unit (GPU) instead of the CPU or in addition to the CPU.

The memory 11 is a storage device of the survival analysis device 1. The memory 11 includes, for example, a hard disk drive (HDD), a solid state drive (SSD), a memory card, or the like. The memory 11 stores information used for the learning operation and the prediction operation of the survival analysis device 1. In addition, the memory 11 stores a learning program for causing the control circuit 10 to execute the learning operation and a prediction program for causing the control circuit 10 to execute the prediction operation.

The communication module 12 is a circuit that is used to transmit and receive data to and from the outside of the survival analysis device 1 via a network, which is not illustrated.

The user interface 13 is a circuit for communicating information between a user and the control circuit 10. The user interface 13 includes an input device and an output device. The input device includes, for example, a touch panel, an operation button, and the like. The output device includes, for example, a liquid crystal display (LCD) or an electroluminescence (EL) display, and a printer. The user interface 13 outputs a result of executing various programs received from the control circuit 10 to the user, for example.

The drive 14 is a device for reading programs stored in a storage medium 15. The drive 14 includes, for example, a compact disk (CD) drive, a digital versatile disk (DVD) drive, or the like.

The storage medium 15 is a medium that accumulates information such as programs by electrical, magnetic, optical, mechanical, or chemical effects. The storage medium 15 may store the learning program and the prediction program.

### 1.1.2 Learning Function Configuration

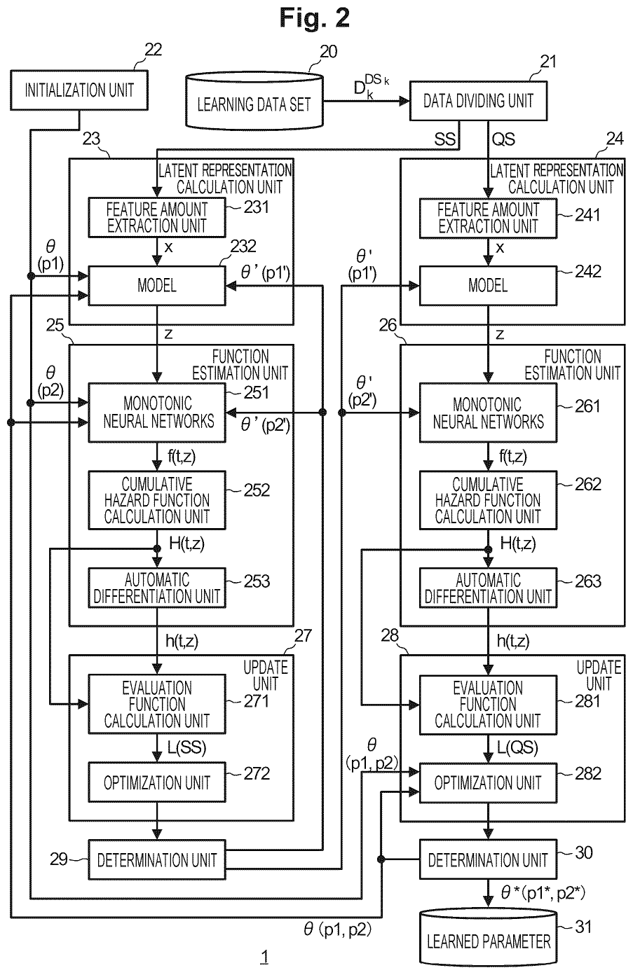

FIG. 2 is a block diagram illustrating an example of a configuration of the learning function of the survival analysis device 1 as the information processing apparatus according to the first embodiment.

The CPU of the control circuit 10 loads the learning program stored in the memory 11 or the storage medium 15 to the RAM. Then, the CPU of the control circuit 10 controls the memory 11, the communication module 12, the user interface 13, the drive 14, and the storage medium 15 by interpreting and executing the learning program loaded to the RAM. In this manner, the survival analysis device 1 functions as a computer including a data dividing unit 21, an initialization unit 22, latent representation calculation units 23 and 24, function estimation units 25 and 26, update units 27 and 28, and determination units 29 and 30 as illustrated in FIG. 2. In addition, the memory 11 of the survival analysis device 1 functions as a learning data set storage unit 20 and a learned parameter storage unit 31 for storing information to be used for the learning operation.

The learning data set storage unit 20 stores a data set Dₖ in accordance with an event to be predicted (hereinafter, the data set will be referred to as a learning data set). The event to be predicted is, for example, a machine failure, a traffic accident, or a life event such as marriage. The learning data set Dₖ is information including d pieces of survival time data X for each of k tasks as follows.

$${D}_{k ∈ K} = {\{ {X}_{k}^{d} \}}_{d ∈ {DS}_{k}} \qquad [ Math . 1 ]$$

(The following description will be given with indexes k and d omitted except for a case where explicit description is particularly needed.)

Here, k is an id of a task, and d is an id of data. Furthermore, DSₖ is a data set of a task k, and K is a task set.

Also, the survival time data X includes a feature amount x, an indication variable δ, and a clock time e.

The indication variable δ takes a value of 1 or 0. δ=1 indicates occurrence of an event, and δ=0 indicates termination. In the case of termination, the survival time data X indicates that only the feature amount x before the occurrence of the event is included.

The meaning represented by the clock time e is determined by the value of the indication variable δ. In other words, the clock time e indicates an event occurrence time in a case where δ=1, and the clock time e indicates a termination time in a case where δ=0.

The feature amount x may be any information as long as the information can be used for the event to be predicted. For example, it is only necessary for the feature amount x to be able to be dealt by the same differentiable model for all tasks. The differentiable model includes, for example, a convolutional neural network (CNN), a recurrent neural network (RNN), or a perceiver. A perceiver is disclosed, for example, in Andrew Jaegle, et al., “Perceiver: General Perception with Iterative Attention”, arXiv: 2103.03206 v2 [cs.CV] 23 Jun. 2021.

In the present embodiment, the event to be predicted is a phenomenon that occurs only once for a person (including a case that is not assumed because data significantly changes after the one-time occurrence), such as a life event, a traffic accident, or a device failure, for example.

The feature amount x may be a stationary feature amount or a time-series feature amount. For example, the stationary feature amount x of the life event is attribute information indicating an attribute of the person such as a sex or an age, for example, and the time-series feature amount x is information such as money income/expense, a position information history, or an SNS posting history, for example. The task k in the learning data set Dₖ of the life event is an event such as marriage, child birth, moving, going to a school for further education, or getting a job. When the feature amount x and the event for the task k is described as task k: (feature amount, event), examples thereof include a task 1: (money income/expense, marriage), a task 2: (position information history+SNS posting history, childbirth), a task 3: (an expense history, moving), . . . . Note that d which is a data id is given to each person.

In a case where the event to be predicted is, for example, a traffic accident, the stationary feature amount x is attribute information indicating an attribute of a driver, for example, and the time-series feature amount x is information such as a sensing data history of various sensors or a dash cam video, for example. The task k in the learning data set Dₖ for a traffic accident is a traffic accident of each nation or area, each vehicle model (a private car, a truck, a taxi, a bus, or the like), or the like. d which is a data id is given for each driving occasion.

The event to be predicted, the feature amount x in each event, the learning data set Dₖ listed here are only examples thereof. It is needless to say that the present invention is not limited to the above example, and for example, the event to be predicted may be a device failure, and the feature amount x in that case may be information such as a model of device, log data, a temperature, or a humidity.

The data dividing unit 21 randomly selects the task k and extracts, from the learning data set Dₖ stored in the learning data set storage unit 20, a data set of the task k:

$${D}_{k}^{{DS}_{k}} \qquad [ Math . 2 ]$$

Hereinafter, this will be referred to as a learning target data set. The data dividing unit 21 randomly divides the extracted learning target data set and acquires a support set SS and a query set QS. The data dividing unit 21 transmits the support set SS to the latent representation calculation unit 23 and transmits the query set QS to the latent representation calculation unit 24.

The initialization unit 22 initializes a parameter set θ on the basis of an arbitrary rule R determined in advance. The parameter set θ includes a plurality of parameters p1 and a plurality of parameters p2. The initialization unit 22 transmits the initialized plurality of parameters p1 to the latent representation calculation unit 23. The initialization unit 22 transmits the initialized plurality of parameters p2 to the function estimation unit 25. Furthermore, the initialization unit 22 transmits the initialized parameter set θ (the plurality of parameters p1 and p2) to the update unit 28. The plurality of parameters p1 and p2 will be described later.

The latent representation calculation unit 23 calculates a latent representation z for the feature amount x of the individual data X of the support set SS on the basis of the support set SS. The latent representation z is data representing a feature of the feature amount x in the data set. The latent 10 representation calculation unit 23 transmits the calculated latent representation z to the function estimation unit 25.

Specifically, the latent representation calculation unit 23 includes a feature amount extraction unit 231 and a model 232. The feature amount extraction unit 231 extracts the feature amount x from the support set SS. The feature amount extraction unit 231 transmits the feature amount x to the model 232. The model 232 is an arbitrary differentiable model that can handle the feature amount x. In other words, the model 232 is a mathematical model modeled to output the latent representation z by using the feature amount x as an input. A CNN, RNN, or Perceiver, for example, may be used as the model 232. The parameter θ (the plurality of parameters p1) are applied as a weight and a bias term to the model 232. The model 232 to which the plurality of parameters p1 are applied uses the feature amount x as an input and outputs the latent representation z. The model 232 transmits the output latent representation z to the function estimation unit 25.

The function estimation unit 25 calculates a hazard function h(t, z) on the basis of the latent representation z and the prediction clock time t. The hazard function h(t, z) is a function of a time representing how likely the event to be predicted is to occur for the data as a target of prediction. The function estimation unit 25 transmits the calculated hazard function h(t, z) to the update unit 27.

Specifically, the function estimation unit 25 includes monotonic neural networks 251, a cumulative hazard function calculation unit 252, and an automatic differentiation unit 253.

The monotonic neural networks 251 are a mathematical model modeled to calculate, as an output, a monotonically increasing function defined by the latent representation z and the clock time t. As the monotonic neural networks 251, it is possible to use, for example, one disclosed in Antoine Wehenkel, et al., “Unconstrained Monotonic Neural Networks”, arXiv:1908.05164v3 [cs.LG] 31 Mar. 2021, one in which a weight is restricted not to be negative by employing an activation function whose differential is positive (such as tanh), or the like. A plurality of weights and bias terms based on the parameter θ (the plurality of parameters p2) are applied to the monotonic neural networks 251. The monotonic neural networks 251 to which the plurality of parameters p2 are applied calculate an output f(t, z) as a scalar value in accordance with a monotonically increasing function defined by the latent representation z and the clock time t. The monotonic neural networks 251 transmit the output f(t, z) to the cumulative hazard function calculation unit 252.

The cumulative hazard function calculation unit 252 calculates a cumulative hazard function H(t, z) on the basis of the output f(t, z) in accordance with the expression described below.

$$H ( t , z ) = s [ f ( t , z ) - f ( 0 , z ) ] \qquad [ Math . 3 ]$$

Here, s is a scale parameter for compensating for insufficient expressing capability of the monotonic neural networks. As a method for determining the scale parameter s, a method of estimating it at the same time with the parameter of the neural network and a method of determining it as a constant from learning data or the like are conceivable. In the latter determination method, the scale parameter s is determined from an upper limit of t considered from H(t)=−log S(t), for example. Note that S(t) is a survival function and represents a probability that the survival time is equal to or greater than t. The cumulative hazard function calculation unit 252 transmits the calculated cumulative hazard function H(t, z) to the automatic differentiation unit 253 and the update unit 27.

The automatic differentiation unit 253 calculates the hazard function h(t, z) by automatically differentiating the cumulative hazard function H(t, z). The automatic differentiation unit 253 transmits the calculated hazard function h(t, z) to the update unit 27. The hazard function h(t, z) is represented by a differential of the cumulative hazard function H(t, z) as follows.

$$H ( t , z ) = {\int }_{0}^{t} h ( u , z ) du \qquad [ Math . 4 ]$$

The update unit 27 calculates the updated parameter set θ (the plurality of parameters p1 and p2) on the basis of the cumulative hazard function H(t, z) and the hazard function h(t, z). The updated parameter set will be described as an updated parameter set θ′ (p1′, p2′). The update unit 27 transmits the updated parameter set θ′ (the plurality of parameters p1′ and p2′) to the determination unit 29.

Specifically, the update unit 27 includes an evaluation function estimation unit 271 and an optimization unit 272.

The evaluation function estimation unit 271 calculates an evaluation function L(SS) on the basis of the cumulative hazard function H(t, z) and the hazard function h(t, z). The evaluation function L(SS) is a negative log likelihood as follows, for example.

$$L ( SS ) = {\sum }_{SS} [ - δ log h ( e , z ) + H ( e , z ) ] \qquad [ Math . 5 ]$$

The evaluation function estimation unit 271 transmits the calculated evaluation function L(SS) to the optimization unit 272.

The optimization unit 272 optimizes the parameter set θ, that is, the plurality of parameters p1 and p2 on the basis of the evaluation function L(SS). A backpropagation method, for example, is used for the optimization. The optimization unit 272 transmits the optimized parameter set θ (the plurality of parameters p1 and p2) as the updated parameter set θ′ (the plurality of parameters p1′ and p2′) to the determination unit 29.

The determination unit 29 determines whether or not a first condition has been satisfied on the basis of the updated parameter set θ′ (the plurality of parameters p1′ and p2′). The first condition may be chat the number of times the updated parameter set θ′ has been transmitted to the determination unit 29 (that is, the number of parameter update loops) is equal to or greater than a threshold value, for example. The first condition may be that an amount of change in values before and after the update of the updated parameter sat θ′ is equal to or less than a threshold value, for example.

In a case where the first condition has not been satisfied, the determination unit 29 applies the updated parameter set θ′ (a plurality of parameters p1′ and p2′) to the model 232 and the monotonic neural networks 251 and causes the latent representation calculation unit 23, the function estimation unit 25, and the update unit 27 to perform a parameter update operation based on the updated parameter set. In other words, in the case where the condition has not been satisfied, the determination unit 29 causes the parameter update loop by the latent representation calculation unit 23, the function estimation unit 25, and the update unit 27 to repeatedly execute.

Also, in a case where the first condition is satisfied, the determination unit 29 causes the parameter update loop to end and transmits the updated parameter set θ′ (the plurality of parameters p1′ and p2′) that has finally been updated to the latent representation calculation unit 24 and the function estimation unit 26. In other words, the determination unit 29 initializes the parameters to be applied to the latent representation calculation unit 24 and the function estimation unit 26 to the updated parameter set θ′ (the plurality of parameters p1′ and p2′).

The latent representation calculation unit 24 calculates the latent representation z for the feature amount x of the individual data X of the query set QS on the basis of the query set QS. The latent representation calculation unit 24 transmits the calculated latent representation z to the function estimation unit 26.

Specifically, the latent representation calculation unit 24 has a configuration corresponding to the latent representation calculation unit 23. In other words, the latent representation calculation unit 24 includes a feature amount extraction unit 241 and a model 242. The feature amount extraction unit 241 extracts the feature amount x from the query set QS. The feature amount extraction unit 241 transmits the feature amount x to the model 242. The model 242 is an arbitrary differentiable model that can handle the feature amount x. The plurality of updated parameters p1′ are applied as weights and bias terms to the model 242. The model 242 to which the plurality of parameters p1′ are applied outputs the latent representation z by using the feature amount x as an input. The model 232 transmits the output latent representation z to the function estimation unit 26.

The function estimation unit 26 calculates the hazard function h(t, z) on the basis of the latent representation z and the prediction clock time t similarly to the function estimation unit 25. The function estimation unit 26 transmits the calculated hazard function h(t, z) to the update unit 27.

Specifically, the function estimation unit 26 includes monotonic neural networks 261, a cumulative hazard function calculation unit 262, and an automatic differentiation unit 263 similarly to the function estimation unit 25.

The monotonic neural networks 261 are a mathematical model that is similar to the monotonic neural networks 251. The plurality of weights and bias terms based on the plurality of updated parameters p2′ are applied to the monotonic neural networks 261. The monotonic neural networks 261 to which the plurality of parameters p2′ are applied calculate an output f(t, z) as a scalar value in accordance with a monotonically increasing function defined by the latent representation z and the clock time t. The monotonic neural networks 261 transmit the output f(t, z) to the cumulative hazard function calculation unit 262.

The cumulative hazard function calculation unit 262 is similar to the cumulative hazard function calculation unit 252 and calculates a cumulative hazard function H(t, z) on the basis of the output f(t, z). The cumulative hazard function calculation unit 262 transmits the calculated cumulative hazard function H(t, z) to the automatic differentiation unit 263 and the update unit 28.

The automatic differentiation unit 263 is similar to the automatic differentiation unit 253 and calculates the hazard function h(t, z) by automatically differentiating the cumulative hazard function H(t, z). The automatic differentiation unit 263 transmits the calculated hazard function h(t, z) to the update unit 28.

The update unit 28 updates the parameter set θ (the plurality of parameters p1 and p2) from the initialization unit 22 on the basis of the cumulative hazard function H(t, z) and the hazard function h(t, z) and transmits the updated parameter set to the determination unit 30.

Specifically, the update unit 28 includes an evaluation function estimation unit 281 and an optimization unit 282 similarly to the update unit 27.

The evaluation function estimation unit 281 calculates an evaluation function L(QS) on the basis of the cumulative hazard function H(t, z) and the hazard function h(t, z). The evaluation function L(QS) is a negative log likelihood as follows, for example.

$$L ( QS ) = {\sum }_{QS} [ - δ log h ( e , z ) + H ( e , z ) ] \qquad [ Math . 6 ]$$

The evaluation function estimation unit 281 transmits the calculated evaluation function L(QS) to the optimization unit 282.

The optimization unit 282 optimizes the parameter set θ, that is, the plurality of parameters p1 and p2, on the basis of the evaluation function L(QS). A backpropagation method, for example, is used for the optimization. More specifically, the optimization unit 282 calculates a second-order derivative regarding the parameter set θ (the plurality of parameters p1 and p2) of the evaluation function L2(QS) by using the parameter set θ (the plurality of parameters p1 and p2) and optimizes θ (the plurality of parameters p1 and p2). The optimization unit 282 transmits the optimized parameter set θ (the plurality of parameters p1 and p2) as an updated parameter set θ (the plurality of parameters p1 and p2) to the determination unit 30.

The determination unit 30 determines whether or not a second condition is satisfied on the basis of the updated parameter set θ (the plurality of parameters p1 and p2). The second condition may be that the number of times the updated parameter set θ has been transmitted to the determination unit 30 (that is, the number of parameter update loops) is equal to or greater than a threshold value, for example. The second condition may be that the amount of change in values before and after the update of the updated parameter set θ is equal to or less than a threshold value, for example. Hereinafter, a case where the second condition is that the number of times the updated parameter set θ has been transmitted to the determination unit 30 is equal to or greater than twice will be described as an example.

In a case where the second condition has not been satisfied, that is, in a case where the updated parameter set θ has been transmitted to the determination unit 30 for the first time, the determination unit 30 transmits the updated parameter set θ (the plurality of parameters p1 and p2) to the optimization unit 282 and applies it to the model 232 and the monotonic neural networks 251. In this manner, the determination unit 30 causes the latent representation calculation units 23 and 24, the function estimation units 25 and 26, the update units 27 and 28, and the determination unit 29 to perform a parameter update operation based on the updated parameter set θ. In other words, in the case where the second condition has not been satisfied, the determination unit 30 causes the parameter update loop again by the latent representation calculation units 23 and 24, the function estimation units 25 and 26, the update units 27 and 28, and the determination unit 29 to execute.

Also, in a case where the second condition has been satisfied, that is, in a case where the number of times the updated parameter set θ has been transmitted to the determination unit 30 is two, the determination unit 30 causes the learned parameter storage unit 31 of the memory 11 to store the updated parameter set θ (the plurality of parameters p1 and p2) as a learned parameter set θ* (a plurality of parameters p1* and p2*).

With the configuration as described above, the survival analysis device 1 has a function of causing the learned parameter storage unit 31 to store the learned parameter set θ* (the plurality of parameters p1* and p2*) on the basis of the learning data set Dₖ stored in the learning data set storage unit 20.

### 1.1.3 Prediction Function Configuration

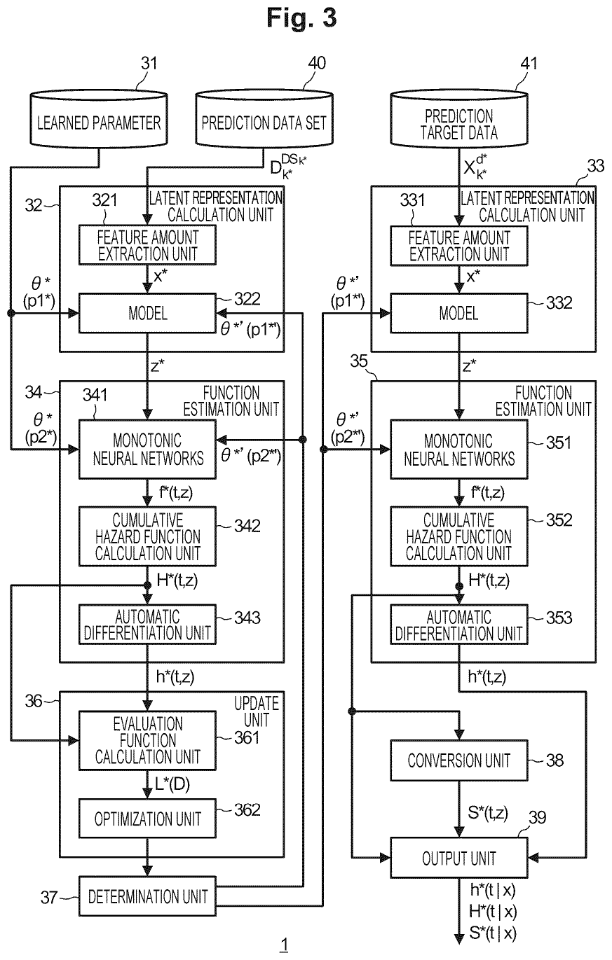

FIG. 3 is a block diagram illustrating an example of a configuration of the prediction function of the survival analysis device 1 as the information processing apparatus according to the first embodiment.

The CPU of the control circuit 10 loads the prediction program stored in the memory 11 or the storage medium 15 to the RAM. Then, the CPU of the control circuit 10 controls the memory 11, the communication module 12, the user interface 13, the drive 14, and the storage medium 15 by interrupting and executing the prediction program loaded to the RAM. In this manner, the survival analysis device 1 further functions as a computer including latent representation calculation units 32 and 33, function estimation units 34 and 35, an update unit 36, a determination unit 37, a conversion unit 38, and an output unit 39 as illustrated in FIG. 3. Also, the memory 11 of the survival analysis device 1 further functions as a prediction data set storage unit 40 and a prediction target data storage unit 41 for storing information used for the prediction operation. Note that FIG. 3 illustrates a case where the plurality of parameters p1* and p2* from the learned parameter storage unit 31 are applied to the model 322 and the monotonic neural networks 341, respectively.

The prediction data set storage unit 40 stores a data set in accordance with a task as a target of prediction (hereinafter, the data set will be referred to as a prediction data set):

$${D}_{{k}^{*}}^{{DS}_{{k}^{*}}} \qquad [ Math . 7 ]$$

(Hereinafter, this will be described as Dₖ*.)

Note that k* is an id of a task that is not included in a task set K in the learning data set Dₖ. In other words, a prediction data set Dₖ* stored in the prediction data set storage unit 40 is a data set that is different from the learning data set Dₖ.

The prediction target data storage unit 41 stores data as a target of prediction (hereinafter, the data will be referred to as prediction target data):

$${X}_{{k}^{*}}^{{d}_{{k}^{*}}} \qquad [ Math . 8 ]$$

(Hereinafter, this will be described as X*.)

Note that dₖ* is an id of data that is not included in a data set DSₖ* of a task k* in the prediction data set Dₖ*. In other words, the prediction target data X* stored in the prediction target data storage unit 41 is data that is not included in the prediction data set Dₖ* and the learning data set Dₖ.

The latent representation calculation unit 32 calculates the latent representation z for the feature amount x of the individual data X in the prediction data set Dₖ* on the basis of the prediction data set Dₖ* in the prediction data set storage unit 40. The latent representation calculation unit 32 transmits the calculated latent representation z to the function estimation unit 34.

Specifically, the latent representation calculation unit 32 has a configuration corresponding to the latent representation calculation unit 23. In other words, the latent representation calculation unit 32 includes a feature amount extraction unit 321 and a model 322. The feature amount extraction unit 321 extracts a feature amount x* from the prediction data set Dₖ*. The feature amount extraction unit 321 transmits the feature amount x* to the model 322. The model 322 is an arbitrary differentiable model that can handle the feature amount x*. The plurality of parameters p1* of the learned parameter set θ* stored in the learned parameter storage unit 31 are applied as weights and bias terms to the model 322. The model 322 to which the plurality of parameters p1* are applied outputs a latent representation z* by using the feature amount x* as an input. The model 322 transmits the output latent representation z* to the function estimation unit 34.

The function estimation unit 34 calculates a hazard function h*(t, z) on the basis of the latent representation z* and the prediction clock time t similarly to the function estimation unit 25. The function estimation unit 34 transmits the calculated hazard function h*(t, z) to the update unit 36.

Specifically, the function estimation unit 34 includes monotonic neural networks 341, a cumulative hazard function calculation unit 342, and an automatic differentiation unit 343 similarly to the function estimation unit 25.

The monotonic neural networks 341 are a mathematical model that is similar to the monotonic neural networks 251. A plurality of weights and bias terms based on a plurality of parameters p2* of the learned parameter θ* stored in the learned parameter storage unit 31 are applied to the monotonic neural networks 341. The monotonic neural networks 341 to which the plurality of parameters p2* are applied calculate an output f*(t, z) as a scalar value in accordance with a monotonically increasing function defined by the latent representation z* and the clock time t. The monotonic neural networks 341 transmit the output f*(t, z) to the cumulative hazard function calculation unit 342.

The cumulative hazard function calculation unit 342 is similar to the cumulative hazard function calculation unit 252 and calculates a cumulative hazard function H*(t, z) on the basis of the output f*(t, z). The cumulative hazard function calculation unit 342 transmits the calculated cumulative hazard function H*(t, z) to the automatic differentiation unit 343 and the update unit 36.

The automatic differentiation unit 343 is similar to the automatic differentiation unit 253 and calculates the hazard function h*(t, z) by automatically differentiating the cumulative hazard function H*(t, z). The automatic differentiation unit 343 transmits the calculated hazard function h*(t, z) to the update unit 36.

The update unit 36 is similar to the update unit 27 and calculates an updated parameter set θ*′ (a plurality of parameters p1*′ and p2*′) on the basis of the cumulative hazard function H*(t, z) and the hazard function h*(t, z). The update unit 36 transmits the updated parameter set θ*′ (the plurality of parameters p1*′ and p2*′) to the determination unit 37.

Specifically, the update unit 36 includes an evaluation function estimation unit 361 and an optimization unit 362 similarly to the update unit 27.

The evaluation function estimation unit 361 calculates an evaluation function L*(D) on the basis of the cumulative hazard function H*(t, z) and the hazard function h*(t, z). The evaluation function L*(D) is, for example, a negative log likelihood as follows:

$$L * ( D ) = {\sum }_{D} [ - δ log h ( e , z ) + H ( e , z ) ] \qquad [ Math . 9 ]$$

The evaluation function estimation unit 361 transmits the calculated evaluation function L*(D) to the optimization unit 362.

The optimization unit 362 optimizes the parameter set θ*, that is, the plurality of parameters p1* and p2* on the basis of the evaluation function L*(D). For the optimization, the backpropagation method, for example, is used similarly to the optimization unit 272. The optimization unit 362 transmits the optimized parameter set θ* (the plurality of parameters p1* and p2*) as an updated parameter set θ*′ (a plurality of parameters p1*′ and p2*′) to the determination unit 37.

The determination unit 37 determines whether or not the first condition has been satisfied on the basis of the updated parameter set θ*′ (the plurality of parameters p1*′ and p2*′) similarly to the determination unit 29. In a case where the first condition has not been satisfied, the determination unit 37 applies the updated parameter set θ*′ (a plurality of parameters p1*′ and p2*′) to the model 322 and the monotonic neural networks 341 and causes the latent representation calculation unit 32, the function estimation unit 34, and the update unit 36 to perform a parameter update operation based on the updated parameter set θ*′. In other words, in the case where the first condition has not been satisfied, the determination unit 37 causes the parameter update loop by the latent representation calculation unit 32, the function estimation unit 34, and the update unit 36 to repeatedly execute. Also, in a case where the first condition has been satisfied, the determination unit 37 causes the parameter update loop to end and finally transmits the updated parameter set θ*′ (the plurality of parameters p1*′ and p2*′) to the latent representation calculation unit 33 and the function estimation unit 35. In other words, the determination unit 37 initializes the parameters to be applied to the latent representation calculation unit 33 and the function estimation unit 35 to the updated parameter set θ*′ (the plurality of parameters p1*′ and p2*′).

The latent representation calculation unit 33 calculates the latent representation z on the basis of prediction target data Xₖ* input from the user through the user interface 13 and stored in the prediction target data storage unit 41, for example. The latent representation calculation unit 33 transmits the calculated latent representation z to the function estimation unit 34.

Specifically, the latent representation calculation unit 33 has a configuration corresponding to the latent representation calculation unit 23. In other words, the latent representation calculation unit 33 includes a feature amount extraction unit 331 and a model 332. The feature amount extraction unit 331 extracts a feature amount x* from the prediction target data Xₖ*. The feature amount extraction unit 331 transmits the feature amount x* to the model 332. The model 332 is an arbitrary differentiable model that can handle the feature amount x*. The plurality of updated parameters p1*′ are applied as weights and bias terms to the model 332. The model 332 to which the plurality of parameters p1*′ are applied outputs a latent representation z* by using the feature amount x* as an input. The model 332 transmits the output latent representation z* to the function estimation unit 35.

The function estimation unit 35 calculates a hazard function h*(t, z) on the basis of the latent representation z* and the prediction clock time t similarly to the function estimation unit 25. The function estimation unit 35 transmits the calculated hazard function h*(t, z) to the output unit 39.

Specifically, the function estimation unit 35 includes monotonic neural networks 351, a cumulative hazard function calculation unit 352, and an automatic differentiation unit 353 similarly to the function estimation unit 25.

The monotonic neural networks 351 are a mathematical model that is similar to the monotonic neural networks 251. A plurality of weights and bias terms based on the plurality of updated parameters p2*′ are applied to the monotonic neural networks 351. The monotonic neural networks 351 to which the plurality of parameters p2*′ are applied calculate an output f*(t, z) as a scalar value in accordance with a monotonically increasing function defined by the latent representation z* and the clock time t. The monotonic neural networks 351 transmit the output f*(t, z) to the cumulative hazard function calculation unit 352.

The cumulative hazard function calculation unit 352 is similar to the cumulative hazard function calculation unit 252 and calculates a cumulative hazard function H*(t, z) on the basis of the output f*(t, z). The cumulative hazard function calculation unit 352 transmits the calculated cumulative hazard function H*(t, z) to the automatic differentiation unit 353, the conversion unit 38, and the output unit 39.

The automatic differentiation unit 353 is similar to the automatic differentiation unit 253 and calculates the hazard function h*(t, z) by automatically differentiating the cumulative hazard function H*(t, z). The automatic differentiation unit 353 transmits the calculated hazard function h*(t, z) to the output unit 39.

The conversion unit 38 converts the cumulative hazard function H*(t, z) transmitted from the cumulative hazard function calculation unit 352 into a survival function S*(t, z). The conversion unit 38 transmits the converted survival function S*(t, z) to the output unit 39.

The output unit 39 outputs, to the user, each of the hazard function h*(t, z) transmitted from the automatic differentiation unit 353 as a hazard function h*(t|x) and the survival function S*(t, z) transmitted from the conversion unit 38 as a survival function S*(t|x). Furthermore, the output unit 39 outputs, to the user, the cumulative hazard function H*(t, z) transmitted from the cumulative hazard function calculation unit 352 as a cumulative hazard function H*(t|x).

With the configuration as described above, the survival analysis device 1 has a function of calculating the hazard function h*(t|x) and the survival function S*(t|x) (and the cumulative hazard function H*(t|x)) for the prediction target data Xₖ* stored in the prediction target data storage unit 41 on the basis of the prediction data set Dₖ* stored in the prediction data set storage unit 40.

### 1.2 Operations

Next, operations of the survival analysis device 1 as the information processing apparatus according to the first embodiment will be described.

### 1.2.1 Learning Operation

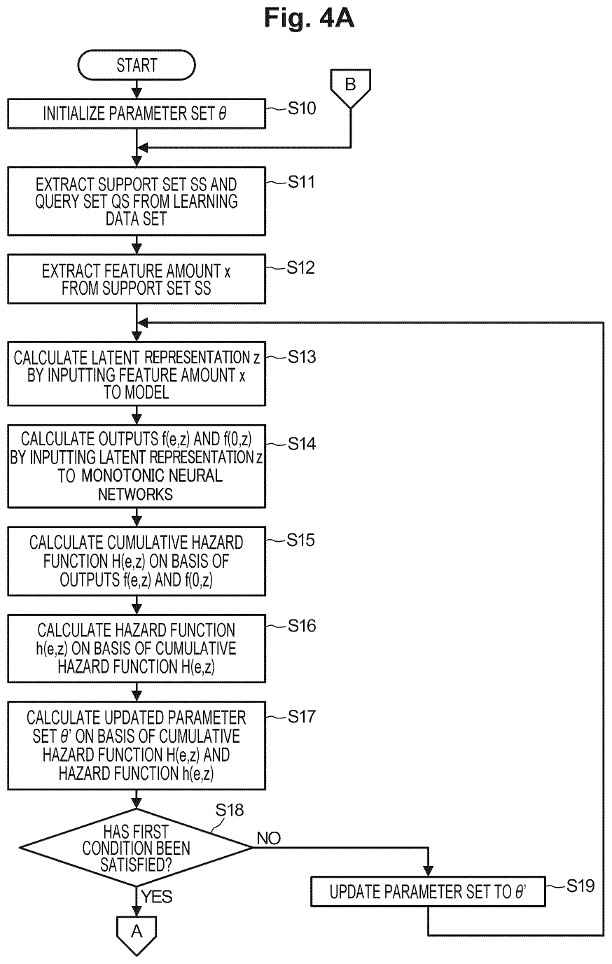

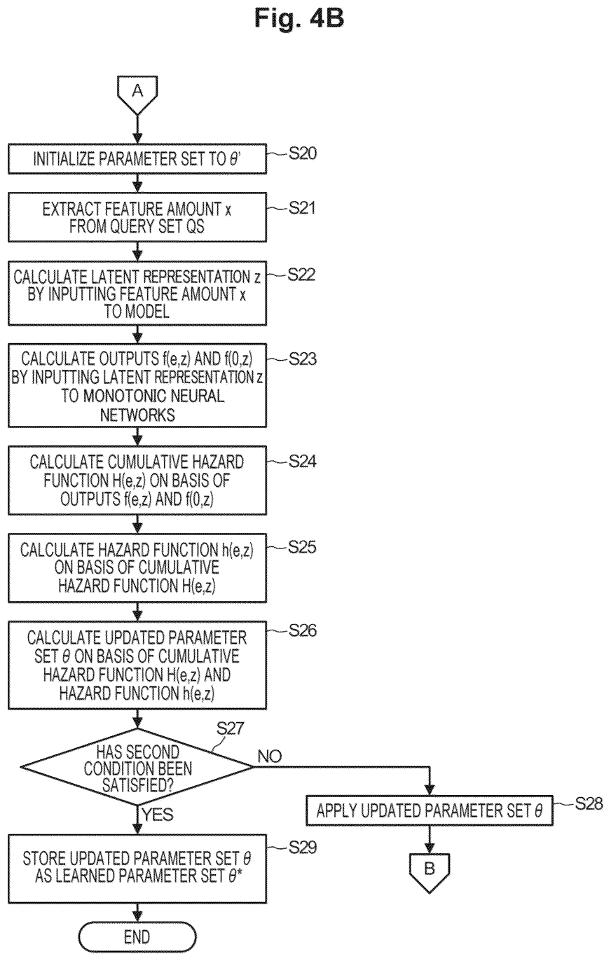

FIGS. 4A and 4B are a series of flowcharts illustrating an example of a learning operation of the survival analysis device 1 as the information processing apparatus according to the first embodiment. In the example illustrated in FIGS. 4A and 4B, it is assumed that a learning data set Dₖ is stored in advance in the learning data set storage unit 20 in the memory 11.

As illustrated in FIG. 4A, in response to an instruction for starting the learning operation from the user (start), the initialization unit 22 initializes a parameter set θ (a plurality of parameters p1 and p2) on the basis of an arbitrary rule R (step S10). For example, the initialization unit 22 initializes the plurality of parameters p1 and p2 on the basis of the arbitrary rule R. The plurality of parameters p1 and p2 initialized through the processing in step S10 are applied to the model 232 and the monotonic neural networks 251, respectively. Furthermore, the initialized parameter set θ (the plurality of parameters p1 and p2) are transmitted to the optimization unit 282.

The data dividing unit 21 randomly extracts a learning target data set of a task k from the learning data set Dₖ stored in the learning data set storage unit 20. Subsequently, the data dividing unit 21 further extracts a support set SS and a query set QS from the extracted learning target data set (step S11).

The feature amount extraction unit 231 extracts a feature amount x of the individual data X of the support set SS from the support set SS extracted through the processing in step S11 (step S12).

The model 232 to which the plurality of parameters p1 initialized through the aforementioned processing in step S10 are applied calculates a latent representation z by using, as an input, the feature amount x of the individual data X of the support set SS extracted through the processing in step S12 (step S13).

The monotonic neural networks 251 to which the plurality of parameters p2 initialized through the aforementioned processing in step S10 are applied calculate outputs f(e, z) and f(0, z) in accordance with a monotonically increasing function defined by the latent representation z calculated through the processing in step S13 and a clock time t (step S14).

The cumulative hazard function calculation unit 252 calculates a cumulative hazard function H(e, z) on the basis of the outputs f(e, z) and f(0, z) calculated through the processing in step S14 (step S15).

The automatic differentiation unit 253 calculates a hazard function h(e, z) on the basis of the cumulative hazard function H(e, z) calculated through the processing in step S15 (step S16).

The update unit 27 calculates an updated parameter set θ′ (a plurality of parameters p1′ and p2′) on the basis of the cumulative hazard function H(e, z) calculated through the aforementioned processing in step S15 and the hazard function h(e, z) calculated in step S16 (step S17). Specifically, the evaluation function estimation unit 271 calculates an evaluation function L(SS) on the basis of the cumulative hazard function H(e, z) and the hazard function h(e, z). The optimization unit 272 calculates the plurality of optimized parameters p1′ and p2′ based on the evaluation function L(SS), that is, the updated parameter set θ′ (the plurality of parameters p1′ and p2′), by using the backpropagation method.

The determination unit 29 determines whether or not the first condition has been satisfied on the basis of the updated parameter set θ′ (the plurality of parameters p1′ and p2′) (step S18).

In a case where the first condition has not been satisfied (step S18; NO), the determination unit 29 updates parameters to be applied to the model 232 and the monotonic neural networks 251 from the aforementioned parameter set θ to the updated parameter set θ′ (the plurality of parameters p1′ and p2′) calculated through the aforementioned processing in step S17 (step S19). Specifically, the determination unit 29 applies the plurality of optimized parameters p1′ and p2′ to the model 232 and the monotonic neural networks 251.

Then, the aforementioned processing in step S13 to S19 is executed on the basis of the updated parameter set θ′ (the plurality of parameters p1′ and p2′) updated through the processing in step S19. In this manner, the update processing of the updated parameter set θ′ (the plurality of parameters p1′ and p2′) is repeated until it is determined that the first condition has been satisfied in the processing in step S18.

In a case where the first condition has been satisfied (step S19: YES), the determination unit 29 initializes parameters to be applied to the model 242 and the monotonic neural networks 261 to the updated parameter set θ′ (the plurality of parameters p1′ and p2′) finally updated in the aforementioned processing in step S18 (step S20) as illustrated in FIG. 4B.

The feature amount extraction unit 241 extracts a feature amount x of the individual data X of the query set QS from the query set QS extracted through the aforementioned processing in step S11 (step S21).

The model 242 to which the plurality of parameters p1′ initialized through the aforementioned processing in step S20 are applied calculates the latent representation z by using, as an input, the feature amount x of the individual data X of the query set QS extracted through the processing in step S21 (step S22).

The monotonic neural networks 261 to which the plurality of parameters p2′ initialized through the aforementioned processing in step S20 are applied calculate outputs f(e, z) and f(0, z) in accordance with a monotonically increasing function defined by the latent representation z extracted through the processing in step S22 and the clock time t (step S23).

The cumulative hazard function calculation unit 262 calculates a cumulative hazard function H(e, z) on the basis of the outputs f(e, z) and f(0, z) calculated through the processing in step S23 (step S24).

The automatic differentiation unit 263 calculates a hazard function h(e, z) on the basis of the cumulative hazard function H(e, z) calculated through the processing in step S24 (step S25).

The update unit 28 calculates an updated parameter set θ (a plurality of parameters p1 and p2) on the basis of the parameter set θ (the plurality of parameters p1 and p2) initialized through the aforementioned processing in step S10, the cumulative hazard function H(e, z) calculated through the aforementioned processing in step S24, and the hazard function h(e, z) calculated in step S25 (step S26). Specifically, the evaluation function estimation unit 281 calculates an evaluation function L(QS) on the basis of the cumulative hazard function H(e, z) and the hazard function h(e, z). The optimization unit 282 calculates an optimized updated parameter set θ (the plurality of parameters p1 and p2) based on the evaluation function L(QS) by using the backpropagation method.

The determination unit 30 determines whether or not the second condition has been satisfied on the basis of the updated parameter set θ (the plurality of parameters p1 and p2) (step S27). Here, the second condition is assumed to be that the number of times the updated parameter set θ has been transmitted to the determination unit 30 is equal to or greater than two, for example.

In a case where the updated parameter set θ has been transmitted to the determination unit 30 for the first time, the determination unit 30 determines that the second condition has not been satisfied. In a case where the second condition has not been satisfied in this manner (step S27: NO), the determination unit 30 updates the parameters to be applied to the model. 232 and the monotonic neural networks 251 from the aforementioned parameter set θ′ (the plurality of parameters p1′ and p2′) to the updated parameter set θ (the plurality of parameters p1 and p2) calculated through the aforementioned processing in step S26 (step S28). Specifically, the determination unit 30 applies the plurality of optimized parameters p1 and p2 to the model 232 and the monotonic neural networks 251.

Thereafter, the aforementioned processing in steps S11 to S26 is executed on the basis of the updated parameter set θ (the plurality of parameters p1 and p2) updated through the processing in step S28. In this manner, the updated parameter set θ (the plurality of parameters p1 and p2) is calculated again.

If the updated parameter set θ (the plurality of parameters p1 and p2) is calculated again and is then transmitted to the determination unit 30 in this manner, the number of times the updated parameter set θ has been transmitted to the determination unit 30 becomes two, and the determination unit 30 thus determines that the second condition has been satisfied through the aforementioned processing in step S27. In the case where the second condition has been satisfied in this manner (step S27: YES), the determination unit 30 causes the learned parameter storage unit 31 to store the updated parameter set θ (the plurality of parameters p1 and p2) calculated 25 in step S26 described above as a learned parameter set θ* (a plurality of parameters p1* and p2*) (step S29).

Once the processing in step S29 ends, the learning operation of the survival analysis device 1 ends (end).

### 1.2.2 Prediction Operation

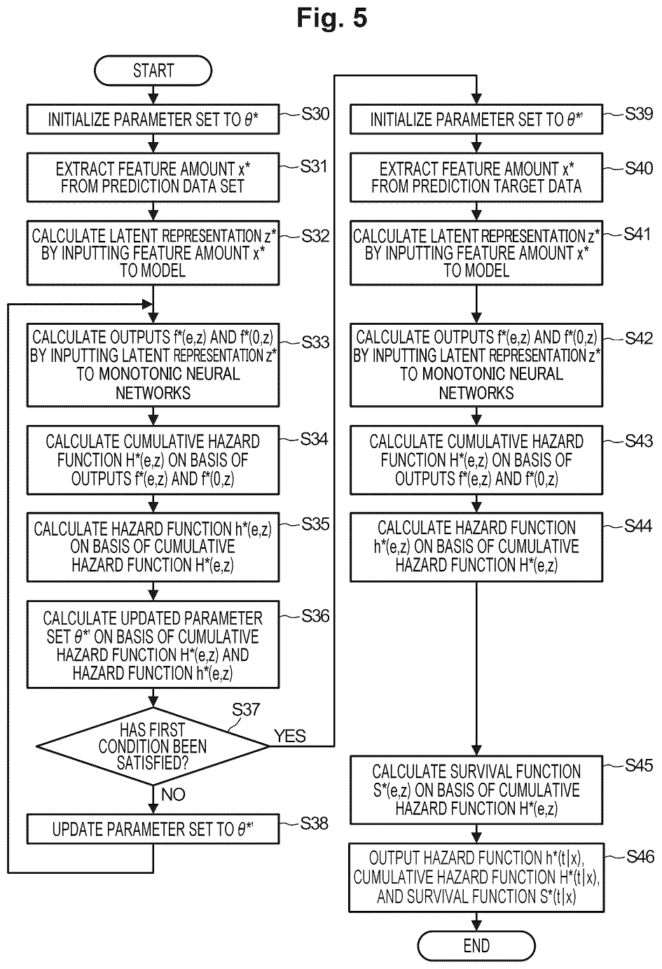

FIG. 5 is a flowchart illustrating an operation of a prediction operation of the survival analysis device 1 as the information processing apparatus according to the first embodiment. In the example in FIG. 5, it is assumed that a prediction data set Dₖ* is stored in the prediction data set storage unit 40 in the memory 11 through a learning operation executed in advance. Also, in the example in FIG. 5, it is assumed that prediction target data Xₖ* is stored in the prediction target data storage unit 41 in the memory 11.

As illustrated in FIG. 5, in response to an instruction for starting the prediction operation from the user (start), the parameters to be applied to the model 322 and the monotonic neural networks 341 are initialized to a learned parameter set θ* (a plurality of parameters p1* and p2*) stored in the learned parameter storage unit 31 (step S30).

The feature amount extraction unit 321 extracts a feature amount x* of the individual data X in the prediction data set Dₖ* from the prediction data set Dₖ* stored in the prediction data set storage unit 40 (step S31).

The model 322 to which the plurality of parameters p1 initialized through the aforementioned processing in step S30 are applied calculates a latent representation z* by using, as an input, the feature amount x* extracted through the processing in step S31 (step S32).

The monotonic neural networks 341 to which the plurality of parameters p2 initialized through the aforementioned processing in step S30 are applied calculate outputs f*(e, z) and f*(0, 2) in accordance with a monotonically increasing function defined by the latent representation z* calculated through the processing in step S32 and the clock time t (step S33).

The cumulative hazard function calculation unit 342 calculates a cumulative hazard function H*(e, z) on the basis of the outputs f*(e, z) and f*(0, z) calculated through the processing in step S33 (step S34).

The automatic differentiation unit 343 calculates a hazard function h*(e, z) on the basis of the cumulative hazard function H*(e, z) calculated through the processing in step S34 (step S35).

The update unit 36 calculates an updated parameter set θ* (a plurality of parameters p1* and p2*) on the basis of the cumulative hazard function H*(e, z) calculated through the aforementioned processing in step S34 and the hazard function h*(e, z) calculated in step S35 (step S36). Specifically, the evaluation function estimation unit 361 calculates an evaluation function L*(D) on the basis of the cumulative hazard function H*(e, z) and the hazard function h*(e, z). The optimization unit 362 calculates the plurality of optimized parameters p1*′ and p2*′ based on the evaluation function L(D), that is, the updated parameter set θ*′ (the plurality of parameters p1*′ and p2\′), by using the backpropagation method.

The determination unit 37 determines whether or not the first condition has been satisfied on the basis of the updated parameter set θ*′ (the plurality of parameters p1*′ and p2*′) (step S37).

In a case where the first condition has not been satisfied (step S37; NO), the determination unit 37 updates parameters to be applied to the model 322 and the monotonic neural networks 341 from the aforementioned parameter set θ* to the updated parameter set θ*′ (the plurality of parameters p1*′ and p2*′) calculated through the aforementioned processing in step S36 (step S38). Specifically, the determination unit 37 applies the plurality of optimized parameters p1*′ and p2*′ to the model 322 and the monotonic neural networks 341.

Then, the aforementioned processing in steps S33 to S38 is executed on the basis of the updated parameter set θ*′ (the plurality of parameters p1*′ and p2*′) updated through the processing in step S38. In this manner, the update processing of the updated parameter set θ*′ (the plurality of parameters p1*′ and p2*′) is repeated until it is determined that the first condition has been satisfied in the processing in step S37.

In a case where the first condition has been satisfied (step S37: YES), the determination unit 37 initializes the parameters to be applied to the model 332 and the monotonic neural networks 351 to the updated parameter set θ*′ (the plurality of parameters p1*′ and p2*′) finally updated through the aforementioned processing in step S36 (step S39).

The feature amount extraction unit 331 extracts a feature amount x* from the prediction target data Xₖ* stored in the prediction target data storage unit 41 (step S40).

The model 332 to which the plurality of parameters p1*′ initialized through the aforementioned processing in step S39 are applied calculates a latent representation z* by using, as an input, the feature amount x* extracted through the processing in step S40 (step S41).

The monotonic neural networks 351 to which the plurality of parameters p2*′ initialized through the aforementioned processing in step S39 are applied calculate outputs f*(e, z) and f*(0, z) in accordance with a monotonically increasing function defined by the latent representation z* calculated through the processing in step S41 and the clock time t (step S42).

The cumulative hazard function calculation unit 352 calculates a cumulative hazard function H*(e, z) on the basis of the outputs f*(e, z) and f*(0, z) calculated through the processing in step S42 (step S43).

The automatic differentiation unit 353 calculates a hazard function h*(e, z) on the basis of the cumulative hazard function H*(e, z) calculated through the processing in step S42 (step S44).

The conversion unit 38 calculates a survival function S*(e, z) on the basis of the cumulative hazard function H*(e, z) calculated through the aforementioned processing in step S43 (step S45).

The output unit 39 outputs, to the user, the hazard function h*(t, z) calculated through the aforementioned processing in step S44 as a hazard function h*(t|x), the cumulative hazard function H*(t, z) calculated through the aforementioned processing in step S43 as a cumulative hazard function H*(t|x), and the survival function S*(t, z) calculated through the processing in step S45 as a survival function S*(t|x) (step S46).

Once the processing in step S46 ends, the prediction operation of the survival analysis device 1 ends (end).

### 1.3 Effects According to First Embodiment

According to the first embodiment, the monotonic neural networks 351 are configured to output the scalar value in accordance with a monotonically increasing function defined by the latent representation calculated by the latent representation calculation unit 33 that calculates the latent representation representing the feature amount regarding the prediction target event from the processing target data including the feature amount and the clock time. The cumulative hazard function calculation unit 352 and the automatic differentiation unit 353 of the function estimation unit 35 estimate the hazard function on the basis of the scalar value output from the monotonic neural networks 351. It is thus possible to avoid integral calculation based on approximation by performing modeling by using the monotonic neural networks 351. Therefore, it is possible to calculate the hazard function for the prediction target data without any assumption.

Also, according to the first embodiment, learning function configurations (the learning data set storage unit 20 to the determination unit 29) that learn, through meta learning based on MAML, the plurality of parameters p1* and p2* (the parameter set θ*) of the latent representation calculation unit 33 and the monotonic neural networks 351 are further included. Therefore, it is possible to calculate the hazard function for the prediction target data even if there is not sufficient prepared prediction obtained when an event to be predicted has occurred.

Also, according to the first embodiment, the latent representation calculation unit 32, the function estimation unit 34, and the update unit 36 that function as a parameter update unit that updates parameters learned by the learning function configurations on the basis of the plurality of pieces of prediction data including the feature amount related to the prediction target event stored in the prediction data set storage unit 40 are included. Therefore, it is possible to more accurately calculate the hazard function by updating the parameters learned through the meta learning based on MAML to parameters in accordance with the prediction target data.

Note that the cumulative hazard function calculation unit 352 of the function estimation unit 35 calculates the cumulative hazard function on the basis of the scalar value output from the monotonic neural networks 351, and the automatic differentiation unit 353 of the function estimation unit 35 calculates the hazard function by automatically differentiating the cumulative hazard function calculated by the cumulative hazard function calculation unit 352. It is thus possible to calculate the hazard function on the basis of the monotonically increasing function.

Also, according to the first embodiment, the conversion unit 38 that converts the cumulative hazard function calculated by the cumulative hazard function calculation unit 352 of the function estimation unit 35 into the survival function is further included. Therefore, it is also possible to calculate the survival function. In this manner, according to the first embodiment, it is possible to calculate at least one of the hazard function and the survival function for the prediction target data without any assumption.

### 2. Second Embodiment

Next, an information processing apparatus according to a second embodiment will be described.

In the information processing apparatus according to the second embodiment, a survival function S(t) is defined as S(t)=1−σ(f(t, z)). Therefore, a cumulative hazard function H(t) is defined as H(t)=−log S(t)=−log{1−σ(f(t, z))}. Here, σ is a function that can be second-order differentiated with a monotonous increase in a value range defined by [0, 1], such as a sigmoid function. The hazard function h(t) is calculated by automatically differentiating the survival function S(t). Therefore, it is possible to calculate the hazard function and the survival function without calculating the cumulative hazard function as in the first embodiment.

Hereinafter, a survival analysis device will be described as an example of the information processing apparatus according to the second embodiment similar to the first embodiment. Hereinafter, configurations and operations that are different from those of the first embodiment will be mainly described. The description of the same configurations and operations as those of the first embodiment will be appropriately omitted.

### 2.1 Configuration

Configurations of the survival analysis device 1 as the information processing apparatus according to the second embodiment will be described.

### 2.1.1 Learning Function Configuration

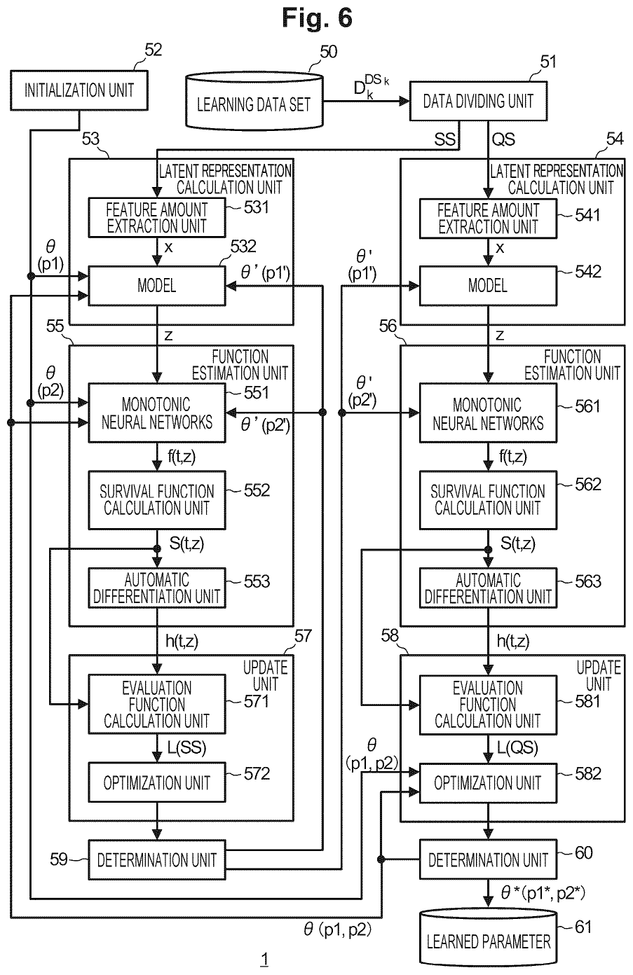

FIG. 6 is a block diagram illustrating an example of a configuration of a learning function of the survival analysis device 1 as the information processing apparatus according to the second embodiment. FIG. 6 corresponds to FIG. 2 in the first embodiment.

As illustrated in FIG. 6, the survival analysis device 1 functions as a computer including a data dividing unit 51, an initialization unit 52, latent representation calculation units 53 and 54, function estimation units 55 and 56, update units 57 and 58, and determination units 59 and 60. In addition, a memory 11 of the survival analysis device 1 functions as a learning data set storage unit 50 and a learned parameter storage unit 61 for storing information to be used for the learning operation.

The configurations of the learning data set storage unit 50 and the data dividing unit 51 are the same as the configurations of the learning data set storage unit 20 and the data dividing unit 21 in FIG. 2 according to the first embodiment. In other words, the data dividing unit 51 extracts a support set SS and a query set QS from the learning data set storage unit 50.

A configuration of the initialization unit 52 is the same as the configuration of the initialization unit 22 in FIG. 2 according to the first embodiment. In other words, the initialization unit 52 initializes the parameter set θ (the plurality of parameters p1 and p2) on the basis of an arbitrary rule R determined in advance. The initialization unit 52 transmits the plurality of initialized parameters p1 to the latent representation calculation unit 53 and transmits the plurality of initialized parameters p2 to the function estimation unit 55. Furthermore, the initialization unit 52 transmits the initialized parameter set θ (the plurality of parameters p1 and p2) to the update unit 58.

A configuration of the latent representation calculation unit 53 is the same as the configuration of the latent representation calculation unit 23 in FIG. 2 according to the first embodiment and includes a feature amount extraction unit 531 and a model 532. In other words, the latent representation calculation unit 53 calculates a latent representation z for a feature amount z of the individual data X of the support set SS on the basis of the support set SS. The latent representation calculation unit 53 transmits the calculated latent representation z to the function estimation unit 55.

The function estimation unit 55 calculates a survival function S(t, z) and a hazard function h(t, z) on the basis of the latent representation z and a clock time t. The function estimation unit 55 transmits the calculated survival function S(t, z) and the hazard function h(t, z) to the update unit 57. Specifically, the function estimation unit 55 includes monotonic neural networks 551, a survival function calculation unit 552, and an automatic differentiation unit 553. Configurations of the monotonic neural networks 551 and the automatic differentiation unit 553 are the same as the configurations of the monotonic neural networks 251 and the automatic differentiation unit 253 in FIG. 2 according to the first embodiment.

The monotonic neural networks 551 to which the plurality of parameters p2 are applied calculate an output f(t, z) in accordance with a monotonically increasing function defined by the latent representation z and the clock time t. The monotonic neural networks 551 transmit the calculated output f(t, z) to the survival function calculation unit 552.

The survival function calculation unit 552 calculates the survival function S(t, z) on the basis of the output f(t, z) from the monotonic neural networks 551. The survival function calculation unit 552 transmits the calculated survival function S(t, z) to the automatic differentiation unit 553. Also, the survival function calculation unit 552 transmits the calculated survival function S(t, z) to the update unit 57.

The automatic differentiation unit 553 calculates a hazard function h(t, z) by automatic differentiating the survival function S(t, z). The automatic differentiation unit 553 transmits the calculated hazard function h(t, z) to the update unit 57.

The update unit 57 calculates an updated parameter set θ′ (a plurality of parameters p1′ and p2′) on the basis of the survival function S(t, z) and the hazard function h(t, z). The update unit 57 transmits the updated parameter set θ′ (the plurality of parameters p1′ and p2′) to the determination unit 59.

Specifically, the update unit 57 includes an evaluation function estimation unit 571 and an optimization unit 572.

A configuration of the evaluation function estimation unit 571 is the same as the configuration of the evaluation function estimation unit 271 in FIG. 2 according to the first embodiment other than that the survival function S(t, z) is used instead of the cumulative hazard function H(t, z). The evaluation function estimation unit 571 calculates an evaluation function L(SS) on the basis of the survival function S(t, z) and the hazard function hit, z). The evaluation function estimation unit 571 transmits the calculated evaluation function L(SS) to the optimization unit 572.

The optimization unit 572 optimizes the parameter set θ, that is, the plurality of parameters p1 and p2, on the basis of the evaluation function L(SS). A backpropagation method, for example, is used for the optimization. The optimization unit 572 transmits the optimized parameter set θ (the plurality of parameters p1 and p2) as the updated parameter set θ′ (the plurality of parameters p1′ and p2′) to the determination unit 59.

The determination unit 59 is the same as the determination unit 29 in FIG. 2 according to the first embodiment. In other words, the determination unit 59 determines whether or not the first condition has been satisfied on the basis of the updated parameter set θ′ (the plurality of parameters p1′ and p2′). In a case where the first condition has not been satisfied, the determination unit 59 causes the parameter update loop by the latent representation calculation unit 53, the function estimation unit 55, and the update unit 57 repeatedly execute. In a case where the first condition has been satisfied, the determination unit 59 causes the parameter update loop to end and transmits the updated parameter set θ′ (the plurality of parameters p1′ and p2′) finally updated to the latent representation calculation unit 54 and the function estimation unit 56. In other words, the determination unit 59 initializes the parameters to be applied to the latent representation calculation unit 54 and the function estimation unit 56 to the updated parameter set θ′ (the plurality of parameters p1′ and p2′).

A configuration of the latent representation calculation unit 54 is the same as the configuration of the latent representation calculation unit 24 in FIG. 2 according to the first embodiment and includes a feature amount extraction unit 541 and a model 542. In other words, the latent representation calculation unit 54 calculates the latent representation z for the feature amount x of the individual data X of the query set QS on the basis of the query set QS. The latent representation calculation unit 54 transmits the calculated latent representation z to the function estimation unit 56.

The function estimation unit 56 calculates the survival function S(t, z) and the hazard function h(t, z) on the basis of the latent representation z and the prediction clock time t similarly to the function estimation unit 55. The function estimation unit 56 transmits the calculated survival function S(t, z) and the hazard function h(t, z) to the update unit 58.

Specifically, the function estimation unit 56 includes monotonic neural networks 561, a survival function calculation unit 562, and an automatic differentiation unit 563 similarly to the function estimation unit 55. Configurations of the monotonic neural networks 551 and the automatic differentiation unit 553 are the same as the configurations of the monotonic neural networks 261 and the automatic differentiation unit 263 in FIG. 2 according to the first embodiment.

The monotonic neural networks 561 to which the plurality of parameters p2′ are applied calculate an output f(t, z) in accordance with a monotonically increasing function defined by the latent representation z and the clock time t. The monotonic neural networks 561 transmit the output f(t, z) to the survival function calculation unit 562.

The survival function calculation unit 562 is similar to the survival function calculation unit 552 and calculates the survival function S(t, z) on the basis of the output f(t, z) from the monotonic neural networks 561. The survival function calculation unit 562 transmits the calculated survival function S(t, z) to the automatic differentiation unit 563 and the update unit 58.

The automatic differentiation unit 563 is similar to the automatic differentiation unit 553 and calculates a hazard function h(t, z) by automatically differentiating the survival function S(t, z). The automatic differentiation unit 563 transmits the calculated hazard function h(t, z) to the update unit 58.

The update unit 58 updates the parameter set θ (the plurality of parameters p1 and p2) from the initialization unit 52 on the basis of the survival function S(t, z) and the hazard function h(t, z) and transmits the updated parameter set to the determination unit 30.

Specifically, the update unit 58 includes an evaluation function estimation unit 581 and an optimization unit 582.

A configuration of the evaluation function estimation unit 581 is the same as that of the evaluation function estimation unit 281 in FIG. 2 according to the first embodiment other than that the survival function S(t, z) is used instead of the cumulative hazard function H(t, z). The evaluation function estimation unit 581 calculates an evaluation function L(QS) on the basis of the survival function S(t, z) and the hazard function h(t, z). The evaluation function estimation unit 581 transmits the calculated evaluation function L(QS) to the optimization unit 582.

The optimization unit 582 optimizes the parameter set θ, that is, the plurality of parameters p1 and p2, on the basis of the evaluation function L(QS). A backpropagation method, for example, is used for the optimization. More specifically, the optimization unit 582 calculates a second-order derivative regarding a parameter set θ (a plurality of parameters p1 and p2) of an evaluation function L2(QS) by using the parameter set θ (the plurality of parameters p1 and p2) and optimizes the parameter set θ (the plurality of parameters p1 and p2). The optimization unit 582 transmits the optimized parameter set θ (the plurality of parameters p1 and p2) as an updated parameter set θ (the plurality of parameters p1 and p2) to the determination unit 60.

The determination unit 60 is the same as the determination unit 30 in FIG. 2 according to the first embodiment. In other words, the determination unit 60 determines whether or not the second condition has been satisfied on the basis of the updated parameter set θ (the plurality of parameters p1 and p2).

In a case where the second condition has not been satisfied, the determination unit 60 transmits the updated parameter set θ (the plurality of parameters p1 and p2) to the optimization unit 582 and applies the updated parameter set θ (the plurality of parameters p1 and p2) to the model 532 and the monotonic neural networks 551. In this manner, the determination unit 60 causes the latent representation calculation units 53 and 54, the function estimation units 55 and 56, the update units 57 and 58, and the determination unit 59 to perform a parameter update operation based on the updated parameter set θ. In other words, in the case where the second condition has not been satisfied, the determination unit 60 causes the parameter update loop by the latent representation calculation units 53 and 54, the function estimation units 55 and 56, the update units 57 and 58, and the determination unit 59 to execute again.

Also, in a case where the second condition has been satisfied, the determination unit 60 causes the learned parameter storage unit 61 to store the updated parameter set θ (the plurality of parameters p1 and p2) as a learned parameter set θ* (a plurality of parameters p1* and p2*).

With the configuration as described above, the survival analysis device 1 has a function of causing the learned parameter storage unit 61 to store the learned parameter set θ* (the plurality of parameters p1* and p2*) on the basis of the learning data set Dₖ stored in the learning data set storage unit 50.

### 2.1.2 Prediction Function Configuration

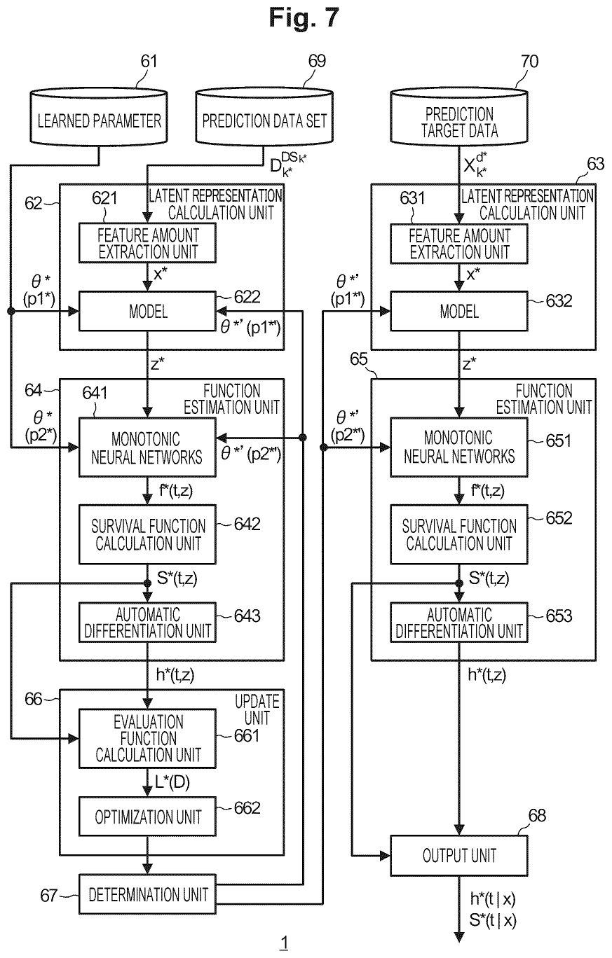

FIG. 7 is a block diagram illustrating an example of a configuration of a prediction function of the survival analysis device 1 as the information processing apparatus according to the second embodiment. FIG. 7 corresponds to FIG. 3 in the first embodiment.

As illustrated in FIG. 7, the survival analysis device 1 further functions as a computer including latent representation calculation units 62 and 63, function estimation units 64 and 65, an update unit 66, a determination unit 67, and an output unit 68. Also, the memory 11 of the survival analysis device 1 further functions as a prediction data set storage unit 69 and a prediction target data storage unit 70 for storing information used for the prediction operation. Note that FIG. 7 illustrates a case where a plurality of parameters p1* and p2* are applied from the learned parameter storage unit 61 to a model 622 and monotonic neural networks 641, respectively.

Configurations of the prediction data set storage unit 69 and the prediction target data storage unit 70 are the same as the configurations of the prediction data set storage unit 40 and the prediction target data storage unit 41 in FIG. 3 according to the first embodiment.

A configuration of the latent representation calculation unit 62 is the same as the configuration of the latent representation calculation unit 32 in FIG. 3 according to the first embodiment and includes a feature amount extraction unit 621 and a model 622. In other words, the latent representation calculation unit 62 calculates a latent representation z for the feature amount x of the individual data X of the prediction data set Dₖ* on the basis of the prediction data set Dₖ* In the prediction data set storage unit 69. The latent representation calculation unit 62 transmits the calculated latent representation z to the monotonic neural networks 641 in the function estimation unit 64.

The function estimation unit 64 calculates the survival function S*(t, z) and the hazard function h*(t, z) on the basis of the latent representation z* and the prediction clock time t similarly to the function estimation unit 55. The function estimation unit 64 transmits the calculated survival function S*(t, z) and the hazard function h*(t, z) to the update unit 66.

Specifically, the function estimation unit 64 includes monotonic neural networks 641, a survival function calculation unit 642, and an automatic differentiation unit 643 similarly to the function estimation unit 55. Configurations of the monotonic neural networks 641 and the automatic differentiation unit 643 are the same as the configurations of the monotonic neural networks 341 and the automatic differentiation unit 343 in FIG. 3 according to the first embodiment.

The monotonic neural networks 641 to which the plurality of parameters p2′ are applied calculate an output f*(z, t) in accordance with the monotonically increasing function defined by the latent representation z* and the clock time t. The monotonic neural networks 641 transmit the calculated output f*(z, t) to the survival function calculation unit 642.

The survival function calculation unit 642 is similar to the survival function calculation unit 552 and calculates the survival function S*(t, z) on the basis of the output f*(t, z) from the monotonic neural networks 641. The survival function calculation unit 642 transmits the calculated survival function S*(t, z) to the automatic differentiation unit 643. Also, the survival function calculation unit 642 transmits the calculated survival function S*(t, z) to the update unit 66.

The automatic differentiation unit 643 is similar to the automatic differentiation unit 553 and calculates a hazard function h*(t, z) by automatically differentiating the survival function S*(t, z). The automatic differentiation unit 643 transmits the calculated hazard function h*(t, z) to the update unit 66.

The update unit 66 calculates an updated parameter set θ*′ (a plurality of parameters p1*′ and p2*′) on the basis of the survival function S*(t, z) and the hazard function h*(t, z). The update unit 66 transmits the updated parameter set θ*′ (the plurality of parameters p1*′ and p2*′) to the determination unit 67.

Specifically, the update unit 66 is similar to the update unit 57 and includes an evaluation function estimation unit 661 and an optimization unit 662.

The evaluation function estimation unit 661 is similar to the evaluation function estimation unit 571 and calculates an evaluation function L*(D) on the basis of the survival function S*(t, z) and the hazard function h*(t, z). The evaluation function estimation unit 661 transmits the calculated evaluation function L*(D) to the optimization unit 662.

The optimization unit 662 is similar to the optimization unit 572 and optimizes the parameter set θ*, that is, the plurality of parameters p1* and p2*, on the basis of the evaluation function L*(D). A backpropagation method, for example, is used for the optimization. The optimization unit 662 transmits the optimized parameter set θ* (the plurality of parameters p1* and p2*) as an updated parameter set θ*′ (a plurality of parameters p1*′ and p2*′) to the determination unit 67.

The determination unit 67 determines whether or not the first condition has been satisfied on the basis of the updated parameter set θ*′ (the plurality of parameters p1*′ and p2*′) similarly to the determination unit 59. In a case where the first condition has not been satisfied, the determination unit 67 applies the updated parameter set θ*′ (the plurality of parameters p1*′ and p2*′) to the model 622 and the monotonic neural networks 641. In other words, in a case where the first condition has not been satisfied, the determination unit 67 causes the parameter update loop by the latent representation calculation unit 62, the function estimation unit 64, and the update unit 66 to repeatedly execute. Also, in a case where the first condition has been satisfied, the determination unit 67 causes the parameter update loop to end and finally transmits the updated parameter set θ*′ (the plurality of parameters p1*′ and p2*′) to the latent representation calculation unit 63 and the function estimation unit 65. In other words, the determination unit 67 initializes the parameters to be applied to the latent representation calculation unit 63 and the function estimation unit 65 to the updated parameter set θ*′ (the plurality of parameters p1*′ and p2*′).

A configuration of the latent representation calculation unit 63 is the same as the configuration of the latent representation calculation unit 33 in FIG. 3 according to the first embodiment and includes a feature amount extraction unit 631 and a model 632. In other words, the latent representation calculation unit 63 calculates the latent representation z on the basis of the prediction target data Xₖ* input from the user through the user interface 13 and stored in the prediction target data storage unit 70, for example. The latent representation calculation unit 63 transmits the calculated latent representation z* to the function estimation unit 65.

The function estimation unit 65 is similar to the function estimation unit 56 and calculates the survival function S*(t, z) and the hazard function h*(t, z) on the basis of the latent representation z* and the prediction clock time t. The function estimation unit 65 transmits the calculated survival function S*(t, z) and hazard function h*(t, z) to the output unit 68.

Specifically, the function estimation unit 65 includes monotonic neural networks 651, a survival function calculation unit 652, and an automatic differentiation unit 653 similarly to the function estimation unit 56. Configurations of the monotonic neural networks 651 and the automatic differentiation unit 653 are the same as the configurations of the monotonic neural networks 351 and the automatic differentiation unit 353 in FIG. 3 according to the first embodiment.

The monotonic neural networks 651 to which the plurality of parameters p2*′ are applied calculate the output f*(t, z) in accordance with a monotonically increasing function defined by the latent representation z* and the clock time t. The monotonic neural networks 651 transmit the output f*(t, z) to the survival function calculation unit 652.

The survival function calculation unit 652 is similar to the survival function calculation unit 562 and calculates the survival function S*(t, z) on the basis of the output f*(t, z) from the monotonic neural networks 651. The survival function calculation unit 652 transmits the calculated survival function S*(t, z) to the automatic differentiation unit 653 and the output unit 68.

The automatic differentiation unit 653 is similar to the automatic differentiation unit 563 and calculates a hazard function h*(t, z) by automatically differentiating the survival function S*(t, z). The automatic differentiation unit 653 transmits the calculated hazard function h*(t, z) to the output unit 68.

The output unit 68 outputs, to the user, each of the hazard function h*(t, z) transmitted from the automatic differentiation unit 653 as a hazard function h*(tx) and the survival function S*(t, z) transmitted from the survival function calculation unit 652 as a survival function S*(t|x).

With the configuration as described above, the survival analysis device 1 has a function of calculating the hazard function h*(t|x) and the survival function S*(t|x) for the prediction target data Xₖ* stored in the prediction target data storage unit 70 on the basis of the prediction data set Dₖ* stored in the prediction data set storage unit 69.

### 2.2 Operations

Next, operations of the survival analysis device 1 as the information processing apparatus according to the second embodiment will be described.

### 2.2.1 Learning Operation

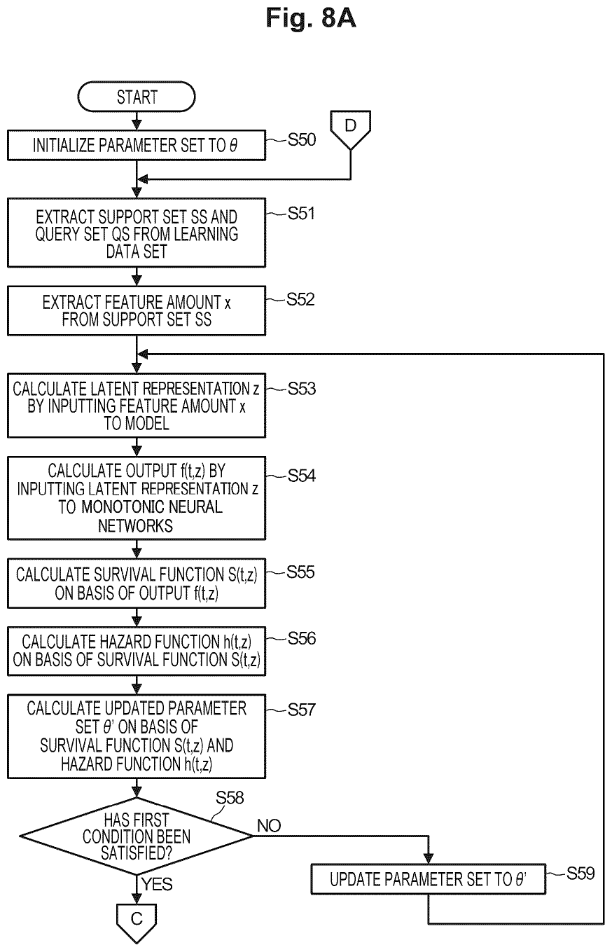

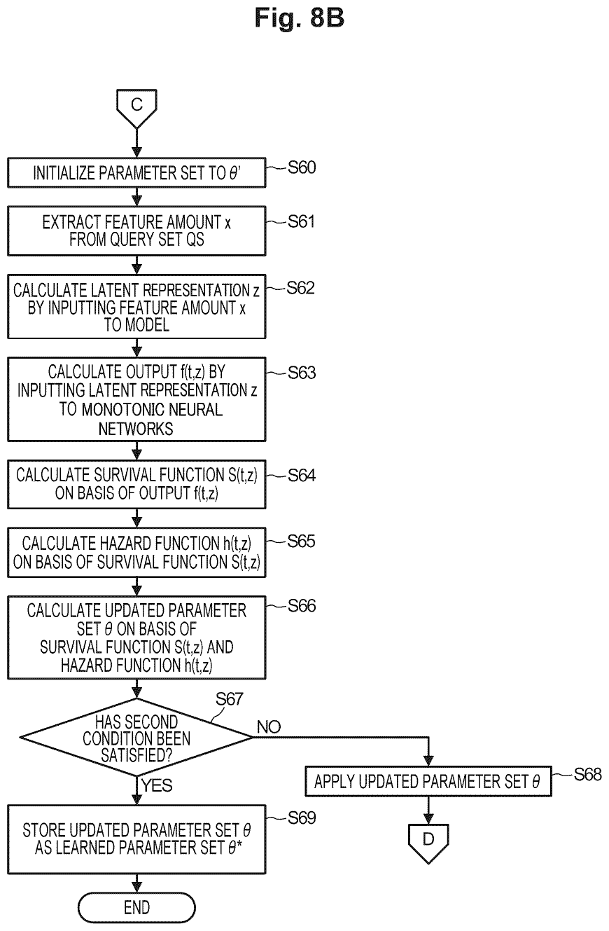

FIGS. 8A and 8B are a series of flowcharts illustrating an example of a learning operation of the survival analysis device 1 as the information processing apparatus according to the second embodiment. FIGS. 8A and 8B correspond to FIGS. 4A and 48 in the first embodiment. In the example illustrated in FIGS. 8A and 8B, it is assumed that a learning data set Dₖ is stored in advance in the learning data set storage unit 50 in the memory 11.

As illustrated in FIG. 8A, in response to an instruction for starting the learning operation from the user (start), processing in step S50 to S53 is executed. The processing in steps S50 to S53 is the same as the processing in steps S10 to S13 in FIG. 4A according to the first embodiment. In other words, the initialization unit 52 initializes a parameter set θ (a plurality of parameters p1 and p2) on the basis of the arbitrary rule R (step S50). The data dividing unit 51 randomly extracts a learning target data set of a task k from the learning data set Dₖ stored in the learning data set storage unit 50 and further extracts the support set SS and the query set QS from the extracted learning target data set (step S51). The feature amount extraction unit 531 extracts a feature amount x of the individual data X of the support set SS from the support set SS extracted through the processing in step S51 (step S52). The model 532 to which the plurality of parameters p1 initialized through the aforementioned processing in step S50 are applied calculates a latent representation z by using, as an input, the feature amount x of the individual data X of the support set SS extracted through the processing in step S52 (step S53).

The monotonic neural networks 551 to which the plurality of parameters p2 initialized through the aforementioned processing in step S50 are applied calculate an output f(t, z) in accordance with a monotonically increasing function defined by the latent representation z calculated through the processing in step S53 and the clock time t (step S54).

The survival function calculation unit 552 calculates a survival function S(t, z) on the basis of the output f(t, z) calculated through the processing in step S54 (step S55).

The automatic differentiation unit 553 calculates a hazard function h(e, z) on the basis of the survival function S(t, z) calculated through the processing in step S55 (step S56).

The update unit 57 calculates an updated parameter set θ′ (a plurality of parameters p1′ and p2′) on the basis of the survival function S(t, z) calculated through the aforementioned processing in step S55 and the hazard function h(t, z) calculated in step S56 (step S57). Specifically, the evaluation function estimation unit 571 calculates an evaluation function L(SS) on the basis of the survival function S(t, z) and the hazard function h(t, z). The optimisation unit 572 calculates the plurality of optimized parameters p1′ and p2′ based on the evaluation function L(SS), that is, the updated parameter set θ′ (the plurality of parameters p1′ and p2′), by using the backpropagation method.

Thereafter, processing in steps S58 to S62 is executed. The processing in steps S58 to S62 is the same as the processing in steps S18 to S22 in FIGS. 4A and 4B according to the first embodiment. In other words, the determination unit 59 determines whether or not the first condition has been satisfied on the basis of the updated parameter set θ′ (the plurality of parameters p1′ and p2′) (step S58). In a case where the first condition has not been satisfied (step S58; NO), the determination unit 59 updates parameters to be applied to the model 532 and the monotonic neural networks 551 from the aforementioned parameter set θ to the updated parameter set θ′ (the plurality of parameters p1′ and p2′) calculated through the aforementioned processing in step S57 (step S59). Specifically, the determination unit 59 applies the plurality of optimized parameters p1′ and p2′ to the model 532 and the monotonic neural networks 551. Then, the aforementioned processing in steps S53 to S59 is executed on the basis of the updated parameter set θ′ (the plurality of parameters p1′ and p2′) updated through the processing in step S59. In this manner, the update processing of the updated parameter set θ′ (the plurality of parameters p1′ and p2′) is repeated until it is determined that the first condition has been satisfied in the processing in step S58.

In a case where the first condition has been satisfied (step S58: YES), the determination unit 59 initializes parameters to be applied to the model 542 and the monotonic neural networks 561 to the updated parameter set θ′ (the plurality of parameters p1′ and p2′) finally updated in the aforementioned processing in step S57 (step S60) as illustrated in FIG. 8B. The feature amount extraction unit 541 extracts a feature amount x of the individual data X of the query set QS from the query set QS extracted through the aforementioned processing in step S51 (step S61). The model 542 to which the plurality of parameters p1′ initialized through the aforementioned processing in step S60 are applied calculates the latent representation z by using, as an input, the feature amount x of the individual data X of the query set QS extracted through the processing in step S41 (step S62).

The monotonic neural networks 561 to which the plurality of parameters p2′ initialized through the aforementioned processing in step S60 are applied calculate an output f(t, z) in accordance with a monotonically increasing function defined by the latent representation z calculated through the processing in step S62 and the clock time t (step S23).

The survival function calculation unit 562 calculates a survival function S(t, z) on the basis of the output f(t, z) calculated through the processing in step S63 (step S64).

The automatic differentiation unit 563 calculates a hazard function h(t, z) on the basis of the survival function S(t, z) calculated through the processing in step S64 (step S65).

The update unit 58 calculates an updated parameter set θ (a plurality of parameters p1 and p2) on the basis of the parameter set θ (the plurality of parameters p1 and p2) initialized through the aforementioned processing in step S50, the survival function S(t, z) calculated through the aforementioned processing in step S64, and the hazard function h(t, z) calculated in step S65 (step S66). Specifically, the evaluation function estimation unit 581 calculates an evaluation function L(QS) on the basis of the survival function S(t, z) and the hazard function h(t, z). The optimization unit 582 calculates an optimized updated parameter set θ (the plurality of parameters p1 and p2) based on the evaluation function L(QS) by using the backpropagation method.

Thereafter, processing in steps S67 to S69 is executed. The processing in steps S67 to S69 is the same as the processing in steps S18 to S22 in FIGS. 4A and 4B according to the first embodiment. In other words, the determination unit 60 determines whether or not the second condition has been satisfied on the basis of the updated 10 parameter set θ (the plurality of parameters p1 and p2) (step S67). In a case where the second condition has not been satisfied (step S67: NO), the determination unit 60 updates the parameters to be applied to the model 232 and the monotonic neural networks 251 from the aforementioned parameter set θ′ (the plurality of parameters p1′ and p2′) to the updated parameter set θ (the plurality of parameters p1 and p2) calculated through the aforementioned processing in step S26 (step S68). Specifically, the determination unit 60 applies che plurality of optimized parameters p1 and p2 to the model 532 and the monotonic neural networks 551. Thereafter, the aforementioned processing in steps S51 to S66 is executed on the basis of the updated parameter set θ (the plurality of parameters p1 and p2) updated through the 25 processing in step S68. In this manner, the updated parameter set θ (the plurality of parameters p1 and p2) is calculated again.

If the updated parameter set θ (the plurality of parameters p1 and p2) is calculated again in this manner, it is determined that the second condition has been satisfied in the aforementioned processing in step S67. Therefore, in this case (step S67: YES), the determination unit 30 causes the learned parameter storage unit 61 to store the updated parameter set θ (the plurality of parameters p1 and p2) calculated in step S66 described above as a learned parameter set θ* (a plurality of parameters p1* and p2*) (step S69).

Once the processing in step S69 ends, the learning operation of the survival analysis device 1 ends (end).

### 2.2.2 Prediction Operation

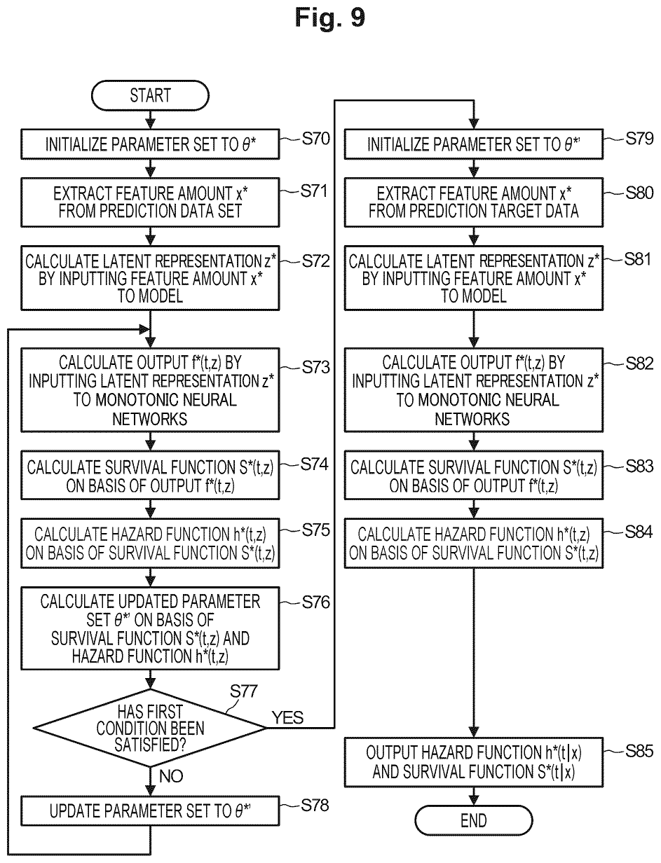

FIG. 9 is a flowchart illustrating an example of a prediction operation of the survival analysis device 1 as the information processing apparatus according to the second embodiment. FIG. 9 corresponds to FIG. 5 in the first embodiment. In the example in FIG. 9, it is assumed that a prediction data set Dₖ* is stored in the prediction data set storage unit 69 in the memory 11 through a learning operation executed in advance. Also, in the example in FIG. 9, it is assumed that prediction target data Xₖ* is stored in the prediction target data storage unit 70 in the memory 11.

As illustrated in FIG. 9, in response to an instruction for starting the prediction operation from the user (start), processing in steps S70 to S72 is executed. The processing in steps S70 to S72 is the same as the processing in steps S30 to S32 in FIG. 5 according to the first embodiment. In other words, the parameters to be applied to the model 622 and the monotonic neural networks 641 are initialized to a learned parameter set θ* (a plurality of parameters p1* and p2*) stored in the learned parameter storage unit 61 (step S70). The feature amount extraction unit 621 extracts a feature amount x* of the individual data X in the prediction data set Dₖ* from the prediction data set Dₖ* stored in the prediction data set storage unit 69 (step S71). The model 622 to which the plurality of parameters p1 initialized through the aforementioned processing in step S70 are applied calculates a latent representation z* by using, as an input, the feature amount x* extracted through the processing in step S71 (step S72).

The monotonic neural networks 641 to which the plurality of parameters p2 initialized by the aforementioned processing of S70 are applied calculate an output f*(t, z) in accordance with a monotonically increasing function defined by the latent representation z* calculated through the processing in step S72 and the clock time t (step S73).

The survival function calculation unit 642 calculates a survival function S*(t, z) on the basis of the output f*(t, z) calculated through the processing in step S73 (step S74).

The automatic differentiation unit 643 calculates a hazard function h*(t, z) on the basis of the survival function S*(t, z) calculated through the processing in step S74 (step S75).

The update unit 66 calculates an updated parameter set θ* (a plurality of parameters p1* and pz*) on the basis of the survival function S*(t, z) calculated through the aforementioned processing in step S74 and the hazard function h*(t, z) calculated in step S75 (step S76). Specifically, the evaluation function estimation unit 661 calculates an evaluation function L*(D) on the basis of the survival function S*(t, z) and the hazard function h*(t, z). The optimization unit 662 calculates a plurality of optimized parameters p1*′ and p2*′ based on the evaluation function L(D), that is, the updated parameter set θ*′ (the plurality of parameters p1*′ and p2*′), by using the backpropagation method.

Thereafter, processing in steps S77 to S81 is executed. The processing in steps S77 to S81 is the same as the processing in steps S37 to S41 in FIG. 5 according to the first embodiment. In other words, the determination unit 37 determines whether or not the first condition has been satisfied on the basis of the updated parameter set θ*′ (the plurality of parameters p1*′ and p2*′) (step S77). In a case where the first condition has not been satisfied (step S77; NO), the determination unit 67 updates parameters to be applied to the model 622 and the monotonic neural networks 641 from the aforementioned parameter set θ* to the updated parameter set θ*′ (the plurality of parameters p1*′ and p2*′) calculated through the aforementioned processing in step S76 (step S78). Specifically, the determination unit 67 applies the plurality of optimized parameters p1*′ and p2*′ to the model 622 and the monotonic neural networks 641. Then, the aforementioned processing in steps S73 to S78 is executed on the basis of the updated parameter set θ*′ (the plurality of parameters p1*′ and p2*′) updated through the processing in step S78. In this manner, the update processing of the updated parameter set θ*′ (the plurality of parameters p1*′ and p2*′) is repeated until it is determined that the first condition has been satisfied in the processing in step S77.

In a case where the first condition has been satisfied (step S77; YES), the determination unit 67 initializes the parameters to be applied to the model 632 and the monotonic neural networks 651 to the updated parameter set θ*′ (the plurality of parameters p1*′ and p2*′) finally updated through the processing in step S76 (step S79). The feature amount extraction unit 631 extracts a feature amount x* from the prediction target data Xₖ* stored in the prediction target data storage unit 70 (step S80). The model 632 to which the plurality of parameters p1*′ initialized through the aforementioned processing in step S79 are applied calculates a latent representation z* by using, as an input, the feature amount x* extracted through the processing in step S78 (step S81).

The monotonic neural networks 651 to which the plurality of parameters p2*′ initialized through the aforementioned processing in step S79 are applied calculate an output f*(t, z) in accordance with a monotonically increasing function defined by the latent representation z* calculated through the processing in step S81 and the clock time t (step S82).

The survival function calculation unit 652 calculates a survival function S*(t, z) on the basis of the output f*(t, z) calculated through the processing in step S82 (step S83).

The automatic differentiation unit 653 calculates a hazard function h*(t, z) on the basis of the survival function S*(t, z) calculated through the processing in step S83 (step S84).

The output unit 68 outputs, to the user, the hazard function h*(t, z) calculated through the processing in step S84 as a hazard function h*(tx) and the survival function S*(t, z) calculated through the aforementioned processing in step $$3 as a survival function S*(t|x) (step S85).

Once the processing in step S85 ends, the prediction operation of the survival analysis device 1 ends (end),

### 2.3 Effects According to Second Embodiment

According to the second embodiment, the monotonic neural networks 651 are configured to calculate, as an output, the monotonically increasing function defined by the latent representation calculated by the latent representation calculation unit 63 that calculates the latent representation representing the feature amount regarding the prediction target event from the processing target data including the feature amount and the clock time. The survival function calculation unit 652 and the automatic differentiation unit 653 of the function estimation unit 65 estimate the survival function and the hazard function on the basis of the monotonically increasing function output from the monotonic neural networks 651. It is thus possible to avoid integral calculation based on approximation by performing modeling by using the monotonic neural networks 651. Therefore, it is possible to calculate the hazard function and the survival function for the prediction target data without any assumption.

Also, according to the second embodiment, learning function configurations (the learning data set storage unit 50 to the determination unit 60) that learn, through meta learning based on MAML, the plurality of parameters p1* and p2* (the parameter set θ*) of the latent representation calculation unit 63 and the monotonic neural networks 651 are further included. Therefore, it is possible to calculate the hazard function and the survival function for the prediction target data even if there is not sufficient prepared prediction obtained when an event to be predicted has occurred.

Also, according to the second embodiment, the latent representation calculation unit 62, the function estimation unit 64, and the update unit 66 that function as a parameter update unit that updates parameters learned by the learning function configurations on the basis of the plurality of pieces of prediction data including the feature amount related to the prediction target event stored in the prediction data set storage unit 69 are included. Therefore, it is possible to more accurately calculate the hazard function and the survival function by updating the parameters learned through the meta learning based on MAML to parameters in accordance with the prediction target data.

Note that the survival function calculation unit 652 of the function estimation unit 65 calculates the survival function on the basis of the scalar value output from the monotonic neural networks 651, and the automatic differentiation unit 653 of the function estimation unit 65 calculates the hazard function by automatically differentiating the survival function calculated by the survival function calculation unit 652. It is thus possible to calculate the hazard function and the survival function on the basis of the scalar value output from the monotonic neural networks 651. Also, since the survival function S(t) is 0≤S(t)≤1, it is not necessary to adjust the scale unlike the cumulative hazard function. Therefore, it is possible to expect an easier learning configuration than that in the first embodiment.

### 3. Modification Examples

Various modifications can be applied to the aforementioned first and second embodiments.

In a case where the feature amount x is time-series data (x0, . . . , Xτ, . . . , xe), for example, it is possible to calculate the likelihood for each clock time, and accordingly, it is thus possible to change a negative log likelihood that is an evaluation function in the first and second embodiments as well. For example, it is possible to change the evaluation function L(SS) in the first embodiment as follows.

$$L ( SS ) = {\sum }_{SS} {\sum }_{0 \leq τ \leq e} [ - δ log h ( e - τ , {z}_{τ} ) + H ( e - τ , {z}_{τ} ) ] \qquad [ Math . 10 ]$$

Note that zτ is z in a case where (x0, . . . , xτ) is input to the model 232 or the like.

The same applies to the other evaluation function.

Note that in a case where the feature amount x includes both the time-series data (x0, . . . , xτ, . . . , xe) and stationary data xs, the data xs is used for calculation of the data zτ.

Also, although the example in which the parameter set is learned through meta learning through MAML has been described for the survival analysis devices 1 as information processing apparatuses according to the first and second embodiments, it is a matter of course that the method of the meta learning is not limited to MAML. Various advanced types have been proposed for MAML, and meta learning may be performed by such advanced types of MAME. Furthermore, the parameter set may be learned by a meta learning method other than MAML.

Also, the survival analysis devices 1 as the information processing apparatuses according to the first and second embodiments may receive a learning program and a prediction program from a program server on a cloud by the communication module 12, store the programs in the memory 11, and perform operations in accordance with the programs. Also, a data set on the cloud may be used as the learning data set storage units 20 and 50 and the prediction data set storage units 40 and 69 instead of the learning data set storage units 20 and 50 and the prediction data set storage units 40 and 69 being provided in the memory 11.

Moreover, the cumulative hazard function may be converted and calculated from the survival function in a case where the cumulative hazard function is output to the user in the second embodiment.

Also, although the case where the learning operation and the prediction operation are executed by the programs stored in the survival analysis devices 1 as the information processing apparatuses according to the first and second embodiments has been described in the embodiments, the present invention is not limited thereto. For example, the learning operation and the prediction operation may be executed by a calculation resource on the cloud.

Moreover, the method described in the embodiments can be distributed by being stored in a recording medium such as a magnetic disk (a Floppy (registered trademark) disk, a hard disk, or the like), an optical disc (a CD-ROM, a DVD, an MO, etc.), or a semiconductor memory (a ROM, a RAM, a flash memory, or the like) as a program (software means) that a calculator (computer) can be caused to execute, or by being transmitted through a communication medium. Note that the programs stored on the medium side also include a setting program for configuring, in the calculator, the software means (including not only an execution program but also a table and a data structure) to be executed by the calculator. The calculator that implements the present device executes the above-described processing by reading the programs recorded in the recording medium and constructing the software means using the setting program as needed, and by the software means controlling operations. Note that the recording medium described in the present specification is not limited to a recording medium for distribution but includes a storage medium such as a magnetic disk or a semiconductor memory provided in the calculator or a device connected via a network.

In short, the present invention is not limited to the aforementioned embodiments, and various modifications can be made in an implementation stage without departing from the gist thereof. Moreover, embodiments may be implemented in an appropriate combination if possible, and in this case, combined advantageous effects can be obtained. Furthermore, the aforementioned embodiments include inventions at various stages, and various inventions can be extracted by appropriate combinations of a plurality of disclosed configuration requirements. For example, even if some configuration requirements are eliminated from all the configuration requirements described in the embodiments, a configuration from which the components are eliminated can be extracted as an invention in a case where the problem can be solved and the advantageous effects can be achieved.

### REFERENCE SIGNS LIST

1 Survival analysis device
10 Control circuit
11 Memory
12 Communication module
13 User interface
14 Drive
15 Storage medium
20, 50 Learning data set storage unit
21, 51 Data dividing unit
22, 52 Initialization unit
23, 24, 32, 33, 53, 54, 62, 63 Latent representation calculation unit
25, 26, 34, 35, 55, 56, 64, 65 Function estimation unit
27, 28, 36, 57, 58, 66 Update unit
29, 30, 37, 59, 60, 67 Determination unit
31, 61 Learned parameter storage unit
38 Conversion unit
39, 68 Output unit
40, 69 Prediction data set storage unit
41, 70 Prediction target data storage unit
231, 241, 321, 331, 531, 541, 621, 631 Feature amount extraction unit
232, 242, 322, 332, 532, 542, 622, 632 Model
251, 261, 341, 351, 551, 561, 641, 651 Monotonic neural networks
252, 262, 342, 352 Cumulative hazard function calculation unit
253, 263, 343, 353, 553, 563, 643, 653 Automatic differentiation unit
271, 281, 361, 571, 581, 661 Evaluation function estimation unit
272, 282, 362, 572, 582, 662 Optimization unit
562, 562, 642, 652 Survival function calculation unit

1. An information processing apparatus comprising a processor including a hardware, configured to:
calculate a latent representation representing a feature amount regarding a prediction target event from processing target data including the feature amount;
inputting the latent representation to monotonic neural networks that are modeled to output a scalar value in accordance with a monotonically increasing function defined by the latent representation and a clock time and obtaining the scalar value from the monotonic neural networks; and
estimate at least one of a hazard function and a survival function on the basis of the scalar value obtained from the monotonic neural networks.

2. The information processing apparatus according to claim 1, wherein the processor is further configured to:
learn parameters of a calculation of the latent representation and the monotonic neural networks, through meta learning and output learned parameters.

3. The information processing apparatus according to claim 2, wherein the processor is further configured to:
update the learned parameters on the basis of a plurality of pieces of prediction data including the feature amount regarding the prediction target event.

4. The information processing apparatus according to claim 3,
wherein, for estimating the hazard function, the processor is configured to:
calculate a cumulative hazard function on the basis of the scalar value obtained from the monotonic neural networks, and
calculate the hazard function by automatically differentiating the cumulative hazard function.

5. The information processing apparatus according to claim 4, wherein the processor is further configured to:
convert the cumulative hazard function into the survival function.

6. The information processing apparatus according to claim 3,
wherein, for estimating the hazard function and the survival function, the processor is configured to:
calculate the survival function on the basis of the scalar value output obtained from the monotonic neural networks; and
calculate the hazard function by automatically differentiating the survival function.

7. An information processing method executed by a processor of an information processing apparatus, comprising:
calculating a latent representation representing a feature amount regarding a prediction target event from processing target data including the feature amount;
inputting the latent representation to monotonic neural networks that is modeled to output a scalar value in accordance with a monotonically increasing function defined by the latent representation and a clock time and obtaining the scalar value from the monotonic neural networks; and
estimating at least one of a hazard function and a survival function on the basis of the scalar value obtained from the monotonic neural networks.

8. A non-transitory tangible computer-readable storage medium storing a program that causes a processor including a hardware in an information processing apparatus to execute:
calculate a latent representation representing a feature amount regarding a prediction target event from processing target data including the feature amount;
input the latent representation to monotonic neural networks that are modeled to output a scalar value in accordance with a monotonically increasing function defined by the latent representation and a clock time and obtain the scalar value from the monotonic neural networks; and
estimate at least one of a hazard function and a survival function on the basis of the scalar value obtained from the monotonic neural networks.

9. The information processing apparatus according to claim 2,
wherein, for estimating the hazard function, the processor is configured to:
calculate a cumulative hazard function on the basis of the scalar value obtained from the monotonic neural networks, and
calculate the hazard function by automatically differentiating the cumulative hazard function.

10. The information processing apparatus according to claim 9, wherein the processor is further configured to:
convert the cumulative hazard function into the survival function.

11. The information processing apparatus according to claim 2,
wherein, for estimating the hazard function and the survival function, the processor is configured to:
calculate the survival function on the basis of the scalar value obtained from the monotonic neural networks; and
calculate the hazard function by automatically differentiating the survival function.

12. The information processing apparatus according to claim 1,
wherein, for estimating the hazard function, the processor is configured to:
calculate a cumulative hazard function on the basis of the scalar value obtained from the monotonic neural networks, and
calculate the hazard function by automatically differentiating the cumulative hazard function.

13. The information processing apparatus according to claim 12, wherein the processor is further configured to:
convert the cumulative hazard function into the survival function.

14. The information processing apparatus according to claim 1,
wherein, for estimating the hazard function and the survival function, the processor is configured to:
calculate the survival function on the basis of the scalar value obtained from the monotonic neural networks; and
calculate the hazard function by automatically differentiating the survival function.
